(19) United States
(12) Patent Application Publication
(10) Pub. No.: US 2019/0370646 A1
(43) Pub. Date: Dec. 5, 2019

(54) Systems And Methods For Making A Product

(71) Applicant: Deakin University, Waurn Ponds, Victoria (AU)

(72) Inventors: Santu Rana, Waurn Ponds, Victoria (AU); Sunil Kumar Gupta, Waurn Ponds, Victoria (AU); Svetha Venkatesh, Waurn Ponds, Victoria (AU); Alessandra Sutti, Waurn Ponds, Victoria (AU)

(21) Appl. No.: 16/091,471

(22) PCT Filed: Apr. 5, 2017
(86) PCT No.: PCT/AU2017/050291

§ 371 Date: Oct. 4, 2018

(30) Foreign Application Priority Data
Apr. 5, 2016 (AU) 2016901256

(51) Int. Cl. G06N 3/08; G06N 5/02; G06N 7/00

(52) U.S. Cl. CPC G06N 3/08; G06N 7/005; G06N 5/02

(57) ABSTRACT

A method used in making a product, wherein a characteristic of the product is at least in part determined by values of parameters used in making the product, the method including the steps of:
(a) applying a machine-based transfer learning process to prior result data, the application of the transfer learning process resulting in the generation of predictive data;
(b) selecting one or more parameter values to be used in making the product based on the generated predictive data;
(c) making the whole or a part of the product using the selected one or more parameter values.

### PRIORITY CLAIM

The present application claims priority to Australian Application No. 2016901256, filed Apr. 5, 2016, and PCT Application No. PCT/AU2017/050291, filed Apr. 5, 2017, both of which are herein incorporated by reference in entirety.

### TECHNICAL FIELD

The present invention generally relates to systems and methods for making a product, e.g., for making a product that meets a desired set of characteristics. The present invention also relates to systems and methods for calculating one or more parameters for use in making a product.

### BACKGROUND

Many industries are involved in making products. For example, manufacturing industries are generally concerned with making products at scale. Materials industries typically focus on the development of new materials. In many cases, the making of a product involves making a product having a set of desired characteristics. To ensure that the end product has the desired set of product characteristics, a series of experiments may be conducted in the product or process development stage to find the best manufacturing conditions, such as: the nature and relative proportions of suitable raw materials, the nature and order of processing steps, and processing conditions (at each processing step).

For example, in the fields of food processing or the development of new material (including new advanced materials, e.g., short polymer fibers, new polymer materials), raw materials go through one or more stages of processing, and each stage is carefully controlled by several parameters. These control parameters directly influence the characteristics of the end-result or output product, including the quality, quantity and cost of the product, as well as other output-specific characteristics such as hardness (for example, in the case of metals) or durability (for example, in the case of plastics). As mentioned above, to determine the values of the control parameters which will provide an output product having desired characteristics, a series of experiments is generally conducted wherein the product is made numerous times, each time with different control parameters. Often the experiments are conducted with slightly varying raw materials or some change in the processes. The nature of the experiments, including the value of the control parameters used in the experiments, may be guided by principles of Design of Experiments (DOE).

As each experiment may involve varying one or more input parameters (of which there may be several), the number of required experiments may be very large, which can be both costly and time consuming, especially when the raw materials are expensive and/or each experiment takes a long time to create a result which may exhibit the desired characteristics. Accordingly, a reduction in the number of required experiments to determine appropriate input parameters to create a product having desired characteristics would be of significant economic benefit, but poses a substantial technical hurdle.

It is desired to address or ameliorate one or more disadvantages or limitations associated with the prior art, or to at least provide a useful alternative.

### SUMMARY

In accordance with embodiments of the present invention, there is provided a method used in making a product, wherein a characteristic of the product is at least in part determined by values of parameters used in making the product, the method including the steps of:
(a) applying a machine-based transfer learning process to prior result data, the application of the transfer learning process resulting in the generation of predictive data;
(b) selecting one or more parameter values to be used in making the product based on the generated predictive data;
(c) making the whole or a part of the product using the selected one or more parameter values.

In accordance with embodiments of the present invention, there is provided a method used in making a product, wherein a characteristic of the product is at least in part determined by values of parameters used in making the product, the method including the steps of:
(a) applying a machine-based transfer learning process to prior result data, the application of the transfer learning process resulting in the generation of predictive data;
(b) selecting one or more parameter values to be used in making the product based on the generated predictive data;
(c) making the whole or a part of the product using the selected one or more parameter values; and
(d) iterating steps (a) to (c) until the whole or part of the made product exhibits one or more desired product characteristics.

In accordance with embodiments of the present invention, there is provided a method used in making a product, wherein a characteristic of the product is at least in part determined by values of parameters used in making the product, the method including the steps of:
(a) applying a machine-based transfer learning process to prior result data, the application of the transfer learning process resulting in the generation of predictive data;
(b) selecting one or more parameter values to be used in making the product based on the generated predictive data;
(c) making or simulating the making of the whole or a part of the product using the selected one or more parameter values.

In accordance with the present invention, there is provided a method used in making a product, wherein a characteristic of the product is at least in part determined by values of parameters used in making the product, the method including the steps of:
(a) applying a machine-based transfer learning process to prior result data, the application of the transfer learning process resulting in the generation of predictive data;
(b) selecting one or more parameter values to be used in making the product based on the generated predictive data;
(c) making or simulating the making of the whole or a part of the product using the selected one or more parameter values; and
(d) iterating steps (a) to (c) until the whole or part of the made or simulated product exhibits one or more desired product characteristics.

In accordance with the present invention, there is provided a method used in making a product, wherein a characteristic of the product is at least in part determined by values of parameters used in making the product, the method including the steps of:
(a) applying a machine-based transfer learning process to prior result data, the application of the transfer learning process resulting in the generation of predictive data;
(b) selecting one or more parameter values to be used in making the product based on the generated predictive data;
(c) simulating the making of the whole or a part of the product using the selected one or more parameter values, and testing the product characteristic of the simulated whole or part of the product;
(d) iterating steps (a)-(c) until the whole or part of the simulated product exhibits one or more desired product characteristics;
(e) outputting the one or more parameter values that were used in simulating the whole or part of the product which exhibited the one or more desired product characteristics.

In accordance with the present invention, there is provided a system used in making a product, wherein a characteristic of the product is at least in part determined by values of parameters used in making the product, the system including:
at least one computer hardware processor;
at least one computer-readable storage medium storing program instructions executable by the at least one computer hardware processor to:
   (a) apply a machine-based transfer learning process to prior result data, the application of the transfer learning process resulting in the generation of predictive data;
   (b) select one or more parameter values to be used in making or simulating the making of the whole or a part of the product based on the generated predictive data; and
   (c) output the selected one or more parameter values.

In accordance with the present invention, there is provided a system used in making a product, wherein a characteristic of the product is at least in part determined by values of parameters used in making the product, the system including:
at least one computer hardware processor;
a product making apparatus;
a product testing apparatus;
at least one computer-readable storage medium storing program instructions executable by the at least one computer hardware processor to:
   (a) apply a machine-based transfer learning process to prior result data, the application of the transfer learning process resulting in the generation of predictive data;
   (b) select one or more parameter values to be used in making or simulating the making of the whole or a part of the product based on the generated predictive data;
   (c) control the product making apparatus to make or simulate the making of the whole or a part of the product;
   (d) control the product testing apparatus to test one or more product characteristics of the whole or part of the product made or simulated;
   (e) determine whether the whole or part of the made or simulated product exhibits one or more desired product characteristics; and
   (f) iterate steps (a)-(e) until the whole or part of the made or simulated product exhibits one or more desired product characteristics.

### BRIEF DESCRIPTION OF THE DRAWINGS

Some embodiments of the present invention are hereinafter further described, by way of example only, with reference to the accompanying drawings, in which:

FIG. 1 is a flow diagram that illustrates an exemplary process of the method used in making a product;

FIG. 2 is a flow diagram that illustrates an exemplary process of the transfer learning process;

FIG. 3 is a flow diagram that illustrates another exemplary process of the transfer learning process;

FIG. 4 is a flow diagram that illustrates a third exemplary process of the transfer learning process;

FIG. 5 is a flow diagram that illustrates an exemplary process of selecting one or more parameter values;

FIG. 6 is a flow diagram that illustrates another exemplary process of selecting one or more parameter values;

FIG. 7 is a flow diagram that illustrates another exemplary process of the method used in making a product;

FIG. 8 is a block diagram of an exemplary product making system implementing the method;

FIG. 9 is a block diagram of an exemplary system used in making a product;

FIG. 10 is a block diagram of another exemplary system used in making a product;

FIG. 11 depicts experimental results of applying of the method used in making a product in a first exemplary experiment; and

FIG. 12 depicts experimental results of applying of the method used in making a product in a second exemplary experiment.

### DETAILED DESCRIPTION OF THE DRAWINGS

As described above, when developing or modifying a product, a series of experiments may be conducted with varied control parameters, to determine the control parameters which would give the product one or more desired characteristics (which could be new or improved characteristics). The control parameters may include, but are not limited to, raw material specifications and measured product properties. The series of experiments typically involve an iterative process having the following steps:
(a) designing and conducting an experiment (i.e. making of a sample of the product) with a first set of control parameters;
(b) measuring the properties of the output product;
(c) determining a further (preferably improved) set of control parameters, different from the first set;
(d) repeating steps (a)-(c), where step (a) is conducted with the further set of control parameters.

The process continues until control parameters are determined which, when used in the product making process, would result in a product having the desired characteristics.

As is clear from the above, in many cases, each experiment in the series of experiments is conducted with slightly varying raw materials or some change in the process from the previous experiment in the series. By conducting a series of experiments, it may be possible to develop or maintain a mathematical model which relates the value of one or more input control parameters (which control the various inputs) to one or more output characteristics. A sufficiently refined model allows the prediction of characteristics of an output product based on specified input parameters.

As described above, model creation, development and refinement can be time-consuming and expensive because of the number of experiments required.

Embodiments of the present invention provide a method to select one or more control parameters to be used in an experiment, using previous knowledge of the product making process (or a process used for making a similar product).

In many circumstances, what is desired to be developed is an improved or modified version of a previous version of product (which could be an experimental sample). The process for making the previous version of the product may have also involved an iterative experimental process.

Accordingly, the previous knowledge that may be used may include knowledge about the previous series' of experiments (being experiments to make previous version(s) of the product). It may also include previous experiments undertaken in an attempt to make the current (desired) version of the product.

It is not necessary that the previous experiments that form the previous knowledge result in the manufacture of a physical item. The experiments may take the form of one or more simulations. A series of simulations may be conducted, each simulation preferably (but not necessarily) having better input parameters than the previous simulation. The series of simulations may also be performed on a pre-defined grid of measurement points in the input space. The results of each simulation can be assessed to determine the characteristics of the output product, had it been made.

Further, it is not necessary that the previous experiments that form the previous knowledge result in making or simulating the making of a whole product. The experiments may only make or simulate a part of the product, e.g., to the extent necessary for an assessment to be made of the desired characteristics.

In some embodiments the previous knowledge includes known reference models that represent some patterns or behaviour of the product making process. Again, in these circumstances it is not necessary to manufacture the product during each experiment.

By utilizing the previous knowledge, the method provided in embodiments of the present invention may reduce the number of experiments required to create or refine the product development model or to identify control parameters which, if used to make the product, would result in a product having the desired characteristics.

Overall Workflow

Where a characteristic of the product is at least in part determined by values of parameters used in making the product, the method used in making a product includes the following steps:
(a) applying a machine-based transfer learning process to prior result data, the application of the transfer learning process resulting in the generation of predictive data;
(b) selecting one or more parameter values to be used in making the product based on the generated predictive data;
(c) making the whole or a part of the product using the selected one or more parameter values.

The term “making the product” includes making a tangible product, and also includes making a simulation model of the product using simulation tools such as computer-based simulation software.

Further, step (c) includes making the whole product using the selected one or more parameter values, and also includes make only a part of the product using the selected one or more parameter values, e.g., to the extent necessary for an assessment to be made of the desired characteristics.

As described above, to calculate a better set of control parameters to be used in a subsequent experiment, a mathematical model which relates the value of input control parameters to the output characteristics may be developed based on experimental data derived from a series of experiments.

However, in many cases there may be very little, if any, experimental data derived from a current experiment or a current series of experiments. (The data derived from a current experiment or a current series of experiments may also be referred to as “current experimental data”).

On the other hand, as mentioned above, there may be previous knowledge about the product making process available, such as the results of past experiments, or past series' of experiments, involving making the product (which may be referred to as “past experimental data” or “source data”). Past experimental data may also include the data derived from one or more simulation(s) based on known reference process models that represent some patterns or behaviour of the product making process.

As at least some aspects of the past experiments and the current experiments are usually the same or similar (as they were directed to the development or manufacture of a similar end product), past experimental data may contain useful information which could inform the selection of parameter values in the current experiments.

However, due to various reasons, such as:
different experimental conditions between the past experiments and the current experiments;
different noise levels between the past experiments and the current experiments;
the inherent inaccuracy of any reference process models; and
deviation of the simulation method/process, directly using the past experimental data in developing the mathematical model may result in the development of a wrong or significantly inaccurate model.

Embodiments of the present invention provide a method that can utilize the past experimental data, by applying a machine-based transfer learning process to information from past experiments to inform the calculation of one or more control parameters to be used in a subsequent experiment.

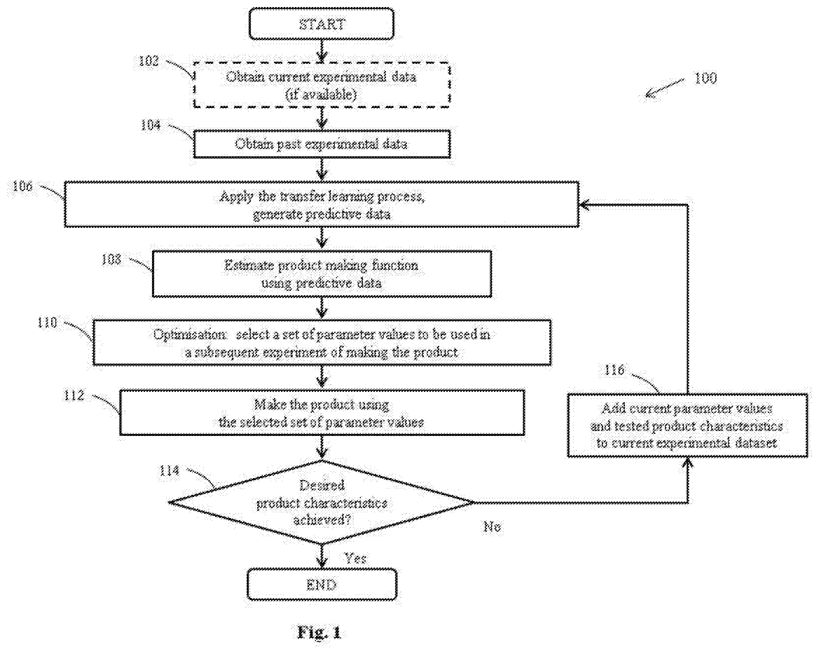

An exemplary process 100 implementing the method described above is depicted in FIG. 1.

As shown in FIG. 1, firstly, in Step 102, the data from results of current experiments or a current series of experiments (current experimental data) is obtained if available.

As mentioned above, making the product includes both making a tangible product, and includes making a simulation model of the product using simulation tools such as computer-based simulation software. Thus, the current experimental data may include results from experiments of making the tangible product, and may also include results from one or more simulations of the current product making process.

Further, as mentioned above, making the product includes making the whole product using the selected one or more parameter values, and also includes make only a part of the product using the selected one or more parameter values, e.g., to the extent necessary for an assessment to be made of the desired characteristics. Thus, the current experimental data may include results from experiments of making or simulating the making of the whole product, and may also include results from making or simulating the making of a part of the product.

Further, as mentioned above, data derived from results of current experiments or a current series of experiments may not be available (that is, such experiments or simulations may not yet have been conducted), in which case Step 102 may be skipped.

Next, in Step 104, past experimental data is obtained. The past experimental data may include process parameters and/or results of past experiments involving the making of tangible products, and may also include process parameters and/or results from past simulations or past series' of simulations of the product making process. In addition, the past experimental data may include results from reverse-engineering, or any other suitable source of generating data related to the product making process (or a process to make a similar product). The obtained past experiment data may be referred to as the “source dataset”.

The past experimental data and the current experimental data (where available) may be referred to together as “prior result data”.

Next, in Step 106, a transfer learning process is applied to the prior result data.

The transfer learning process includes any suitable process that can determine, using the results of past experiments or past series' of experiments, information that may be useful for modeling the current experiment or current series of experiments. Put another way, the transfer learning process may restrict the hypothesis space of the current experiment using data/statistic features from the results of the past experiments. Appropriate transfer learning processes include those based on automatic or collaborative hyperparameter tuning, and transfer learning based on matrix factorization.

The results of the application of some transfer learning processes to prior result data may result in the generation of an augmented dataset. For example, as described in further detail below, a transfer learning process may treat the results from the past series of experiments as noisy observations of the current experimental data, and thereby generate an augmented dataset. This transfer learning process can be used in circumstances when there are the results from the current experiments available, and can also be used in circumstances when there is no result from the current experiment available.

Further, the transfer learning process may include methods that extract one or more statistical features from the past experimental data, rather than generate an augmented dataset. The one or more statistical features may be used to model the product making process.

Many transfer learning processes involve obtaining, extracting or deriving some information from the source dataset that is considered relevant and applicable to the currently conducted experiments. For example, in the case of hyperparameter tuning, the relative weighting or ranking of parameters based on performance (i.e. extent of influence of desired characteristics) is extracted from the source dataset. As described above, in other transfer learning processes, a model representing the source dataset is extracting from the source dataset (and used, with some noise, to model the current series of experiments, also known as the target dataset).

However, the present inventors have found that a more accurate model of the target dataset may be obtained where there are a few initial results from a current series of experiments available, and a transfer learning process is applied which includes comparing the initial results from the current series of experiments with corresponding results from a past series of experiments, calculating or estimating a difference function between the current series of experiments and the past series of experiments, and using the difference function to generate a predictive result for one or more results from the past series of experiments. Such a novel transfer learning process may then combine the generated predictive results with the results from the current series of experiments to create an augmented dataset. The augmented dataset may then be used to model the product making process, and assist in the calculation of the parameters to be used in the next experiment.

The difference function may be derived using any suitable mathematical/statistical methods, including using a probabilistic function, such as a Gaussian Process model or Bayesian Neural Network, or any Bayesian non-linear regression model.

The term “predictive data” is used to refer to the results of the transfer learning process, which may take the form of an augmented dataset, or statistic or other features extracted based on the prior result data.

Next, the process moves to Step 108, which involves using the predictive data to calculate or estimate a function which represents the behaviour of the current product making process.

In some embodiments, a probabilistic function may be derived, using methods including the Gaussian Process method, the Bayesian Neural Network method, or any other suitable method.

Alternatively, the function may be a non-probabilistic function, e.g., in a parametric form, with its parameters derived by suitable machine-learning methods, such as linear regression.

Next, one or more parameter values to be used in making the product, e.g., in the next experiment, are selected in Step 110. The selection of parameter values may also be referred to as “Optimisation”.

The one or more parameter values may be selected by a multitude of suitable methods, including Bayesian optimisation process.

As described above, the behavior of the product making process may be modeled using a Gaussian Process model, which places a prior over smooth functions and updates the prior using the input/output observations under a Bayesian framework. While modeling a function, the Gaussian process also estimates the uncertainties around the function values for every point in the input space. These uncertainties may be exploited to reach a desired value of the output.

Gaussian processes may be parameterized by a mean function, μ(x), and a covariance function, which may also be referred to as a kernel function, k(x, x′). The kernel function includes various types of kernel functions, e.g., exponential kernel functions, squared exponential kernel functions, Matérn kernel functions and rational quadratic kernel functions or any Mercer kernel.

Given an augmented dataset D={x_{n*}, y_{n*}}_{n*=1}^{N*}, the behavior of the product making process may be modeled using the following Gaussian Process model: y_{n*}=ƒ(x_{n*})+€ (where € is the measurement noise), and estimates the d-th component of the function output y_{d} for any input x as

E[y_{d}]=k^{T}K⁻¹vec(Y),var(y_{d})=k(x,x)−k^{T}K⁻¹k,

where Y may be a matrix stacking the output vectors y's for all the training data (n=1, . . . , N) as its rows. The function k may be an appropriate kernel function. Since y is a vector, the kernel function k may be computed by using a combination of a usual kernel function and an extra covariance function over multiple dimensions of y. The vector k contains the values of the kernel function k evaluated using x as the first argument and {x_{n*}}_{n*=1}^{N*} the second argument. The matrix K denotes the kernel matrix, computed using kernel function k, for all pairs of {x_{n*}} in the training dataset. In summary, the above modeling enables us to estimate the output y given an input x.

The one or more parameter values may be selected by the methods referred to above, or any other suitable method.

After Step 110, the process then moves to Step 112, where the product is made using the one or more parameter values selected in Step 110.

In some embodiments, the selected one or more of parameter values may be set by an automatic controller for controlling product making. In some other embodiments, the selected of parameter values may be manually set, e.g., by experimenters/plant operators.

As mentioned above, making the product in Step 112 includes not only making a tangible product, but also making a simulation model of the product using simulation tools such as computer-based simulation software. Further, it includes not only making or simulating the making of the whole product, but also making or simulating the making of a part of the product, e.g., to the extent necessary for an assessment to be made of the desired characteristics.

Next, in Step 114, the product made or simulated is tested to determine whether one or more desired product characteristics have been obtained.

If the one or more desired product characteristics have been obtained, the process 100 ends. If not, the one or more parameter values selected in Step 110 and product characteristics obtained in Step 112 are added to the current experimental dataset (the target dataset).

Steps 106-116 may be iterated until the one or more desired product characteristics are obtained.

In this way, by incorporating past knowledge and/or existing information, the desired product characteristics may be obtained with improved efficiency, as the number of required experiments may be reduced.

Exemplary Product Making Process

Product making processes implementing the above method according to some embodiments are described in further detail below.

In a product making process implementing the method as described above, raw materials go through one or more stages of processing, each stage being controlled by several parameters. The control parameters may affect the characteristics of the product. Such characteristics may include the quality, quantity and cost of the output product, and may also include physical product properties (such as hardness, shape, dimensions, composition or solubility).

The characteristics of the raw materials may be represented by an input vector m, each element of which characterizes a different material property.

In a simple example of a method for making a cake, the elements of the input vector m may be [amount of flour, type of flour, amount of butter, amount of sugar, amount of milk, amount of baking powder, amount of water, number of eggs]. For example, for using 200 grams of wheat flour, 50 grams of butter, 25 grams of sugar, 60 grams of milk, 5 grams of baking powder, 130 grams of and one egg, the vector m may be represented by [200 g, wheat flour, 50 g, 25 g, 60 g, 5 g, 130 g, 1]

As another example, in a method for making polymer fibres, the elements of the input vector m may include [unit formula of the polymer, polymer molecular weight distribution, solvent type and quantity, coagulant type and quantity, viscoelastic moduli, interfacial tensions].

As another example, in a method for making copolymers, the elements of the input vector m may include [monomer formulae, initiator formula, amount of initiator, amount of solvent, percentage presence of oxygen, solubility of the product].

As another example, in a method for making mixtures for dissolving minerals, the elements of the input vector m may include: [absolute quantities of the solvents, solvent molar ratios, chemical structure of the solvents, solvent to material ratio].

As a further example, the method according to embodiments of the present invention may be used to make or design a hull of a rowing shell.

In this case, hulls may be made from composite materials including carbon fibre, Kevlar, glass fibre and honeycomb cores, and structural optimization may be conducted to achieve desired characteristics of the rowing shell, e.g., to achieve maximum stiffness at a prescribed minimum weight.

The elements of the input vector m in this example may include the material type to be used in specific regions and its mechanical properties, e.g., density and stiffness.

The product making process is controlled by one or more process control parameters. The one or more process control parameters may be represented by a vector p.

For example, in the exemplary method of making a cake, the process control parameters vector p may be [mixing time, baking temperature, baking time]. For example, for a mixing time of 8 minutes, a baking temperature at 180° C., and a baking time of 20 minutes, vector p may be represented by [8 mins, 180° C., 20 mins].

In another example, in a process for making polymer fibres, these control parameters (elements of the vector p) may include polymer flow rates, coagulants, temperature, device geometry and device positions.

In a further example, in a process for making copolymers, the control parameters (elements of the vector p) may include monomer ratio, temperature of processing, temperature ramps and dwell time, cooling rates, initiator to monomer ratio, reaction time.

In a further example, in a process for making mixtures for dissolving materials, the control parameters (elements of the vector p) may include temperature, contact time, viscosity.

As another example, in a method for making a hull of a rowing shell, the control parameters (elements of the vector p) may include the thickness and number of layers required and the direction the fibres will be oriented.

Assuming that vector p is Dₚ dimensional and vector m is Dₘ dimensional, the material properties and control Parameters may collectively be represented by a Dₓ dimensional vector x, where

$$x = [ \begin{matrix}m \\ p\end{matrix} ]$$

and Dₓ=Dₘ+Dₚ. For example, in the exemplary method of making a cake, one example of vector x may be [200 g, wheat flour, 50 g, 25 g, 60 g, 5 g, 130 g, 1, 8 mins, 180° C., 20 min], and Dₓ=11.

The output of the product making process may be denoted by a vector y that represents the finished product along with its quality/quantity.

In the exemplary method of making a cake, the product characteristic vector y may be [sponginess, moistness, sweetness, and darkness of colour]. Each element of the vector y may be evaluated using a scale of 1 to 5, each number representing an element of the scale [Not at all, Slightly, Moderately, Very, Extremely]. For example, a cake which is slightly spongy, extremely moist, not sweet at all, and has a moderately dark colour, the vector y may be represented by [2, 5, 1, 3].

In another example, in a process for making polymer fibres, elements of the product characteristic vector y may include length and diameter (average and median values), yield (solids content), presence/absence of unwanted materials (spheres, debris), uniformity of the fibre length and diameter, and aspect ratio (average and median).

In another example, in a process for making copolymers, elements of the product characteristic vector y may include resulting unit ratio, type of copolymer (random, block, etc.), molecular weight distribution, polydispersity, solubility profile, melting point, crystallinity, colour, and intrinsic viscosity.

In another example, in a process for making mixtures for dissolving materials, elements of the product characteristic vector y may include dissolving power (efficacy of the solvent in dissolving target material), Hansen solubility parameters, viscosity, cost, hazard (flammability, corrosion properties, etc.), polarity, acidity, physical state at room temperature, and surface tension.

As another example, in a method for making a hull of a rowing shell, elements of the product characteristic vector y may include quantitative assessment of the compliance (e.g., stiffness) of the hull structure, e.g., deflection at critical points on the structure and/or strains in specific regions.

The product making process may be modeled by a function ƒ, where y=ƒ(m, p).

Transfer Learning

In Step 106 of the process 100, a machine-based transfer learning process is applied to prior result data, the application of the transfer learning process resulting in the generation of predictive data.

The prior result data may include any kind of previously known data relevant to the making of the product, including data obtained:
from one or more previous series of experiments;
from one or more previous experiments in the current series;
from one or more simulations of a product making process; and
via reference process models.

The prior result data may include prior parameter values for making the product and one or more prior product characteristics, being the product characteristics corresponding to the prior parameter values (that is, the characteristics of the product when made using the prior parameter values).

Using the above notation, the prior parameter values may include values of the elements of the vector x. The prior product characteristics may include values of the elements of the vector y.

In the exemplary method of making a cake, the prior result data may include the following prior parameter values and corresponding prior product characteristics:
x₁=[200 g, wheat flour, 55 g, 25 g, 60 g, 5 g, 130 g, 1, 6 mins, 160° C., 15 mins];
y₁=[2, 5, 4, 1].
x₂=[210 g, white flour, 55 g, 20 g, 60 g, 6 g, 140 g, 1.5, 4 mins, 180° C., 15 mins];
y₂=[4, 5, 3, 2].
x₃=[205 g, wheat flour, 50 g, 10 g, 60 g, 6.5 g, 140 g, 1, 6 mins, 180° C., 20 mins];
y₃=[5, 4, 1, 3].
x₄=[200 g, mixed flour, 50 g, 30 g, 60 g, 4.5 g, 130 g, 2, 5 mins, 200° C., 15 mins];
y₄=[1, 3, 5, 3].
x₅=[200 g, white flour, 45 g, 15 g, 60 g, 4.5 g, 130 g, 1, 6 mins, 200° C., 25 mins];
y₅=[1, 2, 2, 5].

The prior parameter values and the corresponding prior product characteristics may include parameter values and corresponding product characteristics derived from past experiments. As described above, the past experiments may consist of one or more series' of past experiments, and/or one or more experiments in the current series. The parameter values and corresponding product characteristics may be directly known from the past experiments, or may be deduced (e.g., by reverse engineering) from products produced as a result of the execution of past experiments.

The predictive data generated as a result of the application of the machine-based transfer learning process may include predictive parameter values for making the product and one or more corresponding predictive product characteristics. The predictive parameter values and the corresponding predictive product characteristics may be generated based at least in part on the prior parameter values and the corresponding prior product characteristics.

In some embodiments, the transfer learning process in Step 106 may include comparing a first group of the prior parameter values and corresponding prior product characteristics with a second group of the prior parameter values and corresponding prior product characteristics. This is further discussed below.

Harnessing Past Experimental Data Through Transfer Learning

In some embodiments, a plurality of values of x and corresponding values of y are obtained from a past series of experiments involving making the product. A new series of experiments involving one or more iterations of making the product is carried out, with a small number of new values of x being used to generate corresponding values of y (the undertaking of a small number of experiments to obtain initial x and y values may be referred to as a “cold start”, as no previous values of x and y are used at the commencement of the series of experiments). In this case, the first group of prior parameter values and corresponding prior product characteristics may include data from the past series of experiments, denoted as Dₚ={xⱼ, yⱼ}ⱼ₌₁^{J}. The second group of prior parameter values and corresponding prior product characteristics may include data from the current series of (one or more) experiments, denoted as D_{c}={xₙ, yₙ}ₙ₌₁^{N}.

In some embodiments, the past series of experiments involving making the product may be conducted under different conditions from the current series of experiments, i.e., {xⱼ, yⱼ}ⱼ₌₁^{J} are derived under different conditions from {xₙ, yₙ}ₙ₌₁^{N}.

As described above, although any suitable machine-based transfer learning process may be used, a process that involves a comparison between the first group of the prior parameter values (with their corresponding prior product characteristics) and the second group of the prior parameter values (with their corresponding prior product characteristics) may lead to better predictive data. As described below, such a comparison-based transfer learning process may be carried out in different ways, e.g., learning and refining a difference function between a past series of experiments and the current series of experiments, treating past experimental data as noisy observations of the current experimental process where the noise level is refined based on the results of the current series of experiments, etc.

(a) Learning and Refining a Difference Function Between a Past Series of Experiments and the Current Series of Experiments

The functionality of the past series of experiments and the current series of experiments may be modeled respectively as following:
(yⱼ)ₚₐₛₜ=ƒₚₐₛₜ (xⱼ), for all data from the past experiments;
(yₙ)_{current}=ƒ_{current} (xₙ), for all data from the current experiments.

It may be assumed that the respective output measurements from the two series of experiments have respective noise levels. Thus:
(yⱼ)ₚₐₛₜ=ƒₚₐₛₜ (xⱼ)+€ₚₐₛₜ1, for all data from the past experiments;
(yₙ)_{current}=ƒ_{current} (xₙ)+€_{current}1, for all data from the current experiments;
where the measurement noises may be distributed as €ₚₐₛₜ˜ [symbol] (0, σₚₐₛₜ²) and current €_{current}˜ [symbol] (0, σ_{current}²), and 1 denotes a vector having all its elements being one.

The parameter values and product characteristics of the current series of experiments {xₙ, yₙ}ₙ₌₁^{N} may be compared with the parameter values and product characteristics of the previous series of experiments {xⱼ, yⱼ}ⱼ₌₁^{J} to enable the calculation of a difference function between them. Accordingly, the predictive parameter values and the corresponding predictive product characteristics may be generated in the transfer learning process based on the difference between the first group of prior parameter values and corresponding prior product characteristics (for example, being those of the previous series of experiments) and the second group of prior parameter values and corresponding prior product characteristics (for example, being those of the current series of experiments).

Specifically, the functionality of the current series of experiments may be modeled as the following:

ƒ_{current}(x)=ƒₚₐₛₜ(x)+g(x),

where the function g(x) models the difference between the current experimental function ƒ_{current} and the past experimental function ƒₚₐₛₜ.

Since the difference function g(x) may be a nonlinear function, it may be estimated using a probabilistic model, e.g., Gaussian Process model, Bayesian Neural Network, or any Bayesian non-linear regression model.

In some embodiments, the difference function g(x) may be estimated using a Gaussian process, e.g., as g(x)˜GP (μ(x), k_{g} (x, xₙ)), where k_{g} is a suitable covariance function.

At any point of x, g(x) may be estimated as a random vector following an i.i.d. (independent and identically distributed) multi-variate normal distribution with mean μ(x) and co-variance σ_{g}²(x)I.

Specifically, g(x) may be estimated by predicting function values of the past experimental function ƒₚₐₛₜ on the evaluated settings xₙ of the current experiments and creating a training dataset {xₙ, ƒ_{current} (xₙ)−ƒₚₐₛₜ(xₙ)}ₙ₌₁^{N}.

In some embodiments, there may be no data available from the current series of experiments. In those cases, the mean function μ may be assumed to be zero and the co-variance matrix may be assumed to be an appropriate matrix, e.g., a matrix reflecting a prior belief on the similarity between the two experiments.

Once the difference function g(x) is derived, the predictive data which includes predictive parameter values and the corresponding predictive product characteristics may then be generated based on g(x), by correcting the past experimental data through the difference function g(x).

The predictive data may include a new augmented dataset created as

D=D_{c}∪{xⱼ,ƒₚₐₛₜ(xⱼ)+g(xⱼ)}ⱼ₌₁^{J}.

This augmented dataset is used in Step 108 of the process 100.

The current series of experiments may include a plurality of iterations of making the product, in which case the difference function g(x) may be updated through the course of the current series experiments, using the newly available observations from the new iteration and the updated training dataset {xₙ, ƒ_{current} (xₙ)−ƒₚₐₛₜ(xₙ)}ₙ₌₁^{N}.

In addition, as described in further detail below, predicted uncertainties of g(xⱼ)∀ⱼ may be used in Steps 108 and 110 to alter the Gaussian process kernel matrix.

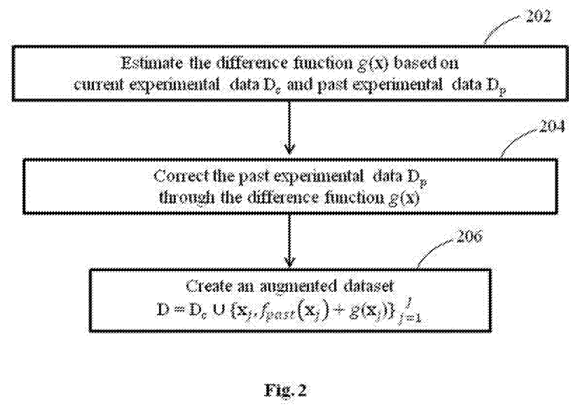

FIG. 2 is a flow diagram that illustrates an exemplary process of the Step 106 according to one embodiment, in which a machine-based transfer learning process based on a difference function is applied to past experimental data to generate predictive data.

As shown in FIG. 2, in Step 202, the process estimates the difference function g(x) based on current experimental data D_{c} and past experimental data Dₚ. The process then moves to Step 204, correcting the past experimental data Dₚ through the difference function g(x). Next, in Step 206, an augmented dataset D=D_{c}∪{xⱼ, ƒₚₐₛₜ(xⱼ)+g(xⱼ)}ⱼ₌₁^{J} is created.

(b) Treating Past Experimental Data as Noisy Observations of the Current Experimental Process

Alternatively, the data from the past series of experiments may be treated as noisy measurements of the current function ƒ_{current}, as yⱼ=ƒ_{current}(xⱼ)+€ⱼ1, ∀j=1, . . . , J, where €ⱼ˜ [symbol] (0, σⱼ²) is a random noise, and 1 denotes a vector having all its elements being one.

The noise variance (σⱼ²) may be initially set high and may be refined through the course of the current experiments.

Similarly, the predictive parameter values may include a new augmented dataset created as D=D_{c} ∪{xⱼ, ƒₚₐₛₜ(xⱼ))}ⱼ₌₁^{J}. The augmented dataset D goes into the next step of the process, i.e., Step 108.

Further, due to the extra noise associated with the noise data, the Kernel matrix in Steps 108 and 110 may be updated by adding the noise variance in the diagonals which correspond to the data from the past series of experiments.

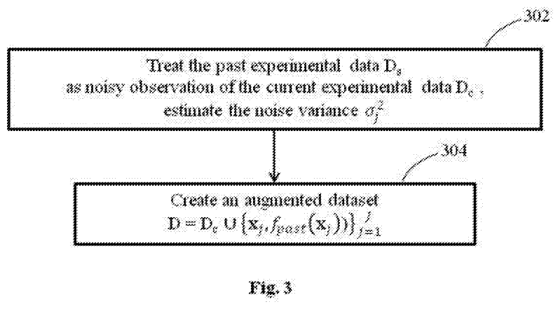

FIG. 3 is a flow diagram illustrating the exemplary process of the Step 106 according to another embodiment, in which a machine-based transfer learning process based on a noisy measurements model is applied to past experimental data to generate predictive data.

As shown in FIG. 3, in Step 302, the process treats the past experimental data Dₚ as noisy observation of the current experimental data D_{c}, and estimates the noise variance €ⱼ accordingly. Next, in Step 304, an augmented dataset D=D_{c} €{xⱼ, ƒₚₐₛₜ(xⱼ))}ⱼ₌₁^{J} is created.

(c) Matrix Factorization Based Transfer Learning

Alternatively, a matrix may be constructed where columns correspond to various experimental settings and rows correspond to various past experiments. The last row of the matrix corresponds to the current series of experiments. For a bounded discrete space, the matrix may have a finite number of columns; while for a continuous space, the matrix may have an infinite number of columns.

Since the total number of past experiments and the number of experiment trials for each such past experiment is finite, the matrix may have a finite number of columns.

The (i, j)-th element of the matrix is the response of i-th experiment on j-th experimental setting. This matrix is sparse and has many missing elements.

A non-linear matrix factorization (akin to a collaborating filtering problem) may be used to fill in the missing elements for the current experiment, which provides an augmented experimental set additionally providing estimated current function values at all the experimental settings used for past experiments.

(d) Transfer Learning Modeling Deviation from the Mean of Outcome

Alternatively, past experimental data may be used to derive a function that models deviation from the mean of outcome. It may be assumed that the deviation functions are the same in both the past and the current experiments. Mean function values of the past experiment may be subtracted from the actual function values of the past experiment and then this altered dataset may be used to augment the data from the current experiment. For the current experiment also, the mean is subtracted from the actual function values.

The Augmented Dataset

D={xₙ,ƒ_{current}(xₙ)−ƒ̅_{current}(xₙ)}ₙ₌₁^{N}∪{xⱼ,ƒₚₐₛₜ(xⱼ)−ƒ̅ₚₐₛₜ(xⱼ)}ⱼ₌₁^{J}

is then used in the next step of the process, i.e., Step 108.

(e) Transfer Learning Based on the Ranking

Alternatively, past experimental data may be used to find the ranking of the experimental settings, i.e., replacing actual output (yₙ, ∀ₙ) with its rank (rank(yₙ)). It may be assumed that the current series of experiments has same ranking behavior. The altered data from past experiment is used to augment the current experimental data ({xₙ, rank(yₙ)}ₙ₌₁^{N}), and this augmented dataset is used in the next step of the process, i.e., Step 108.

Harnessing Simulation or Reference Model Data Through Transfer Learning

In some embodiments, the prior parameter values and the corresponding prior product characteristics may include simulated data generated based on a reference model.

In many cases, specifications for equipment that is used to make a product (e.g. plant specifications) may be available via reference process models. Simulation data simulated based on the reference models may be used to improve the optimisation process.

For example, simulation data Dₛ={(xⱼ, yⱼ), ∀j=1, . . . , J} may be synthesized from a reference model.

In the transfer learning process, the simulation data Dₛ may be modeled as noisy measurements of the actual function ƒ:

yⱼ=ƒ(xⱼ)+€ⱼ1,∀j=1, . . . ,J

where €ⱼ˜ [symbol] (0, σⱼ²) is a random noise, and 1 denotes a vector having all its elements being one. The noise models the deviation of real process from the reference model.

The measurement during the current series of experiments D_{c}={(xₙ, yₙ), ∀n=1, . . . , N} may be noisy and may be represented as

yₙ=ƒ(xₙ)+€ₙ1,∀n=1, . . . ,N

where the noise is distributed as €ₙ˜ [symbol] (0, σⱼ²), and 1 denotes a vector having all its elements being one.

It may be assumed that the plant has been designed so that with a high probability (e.g. six-sigma) the actual behavior lies within q % of the design specification, i.e.,

$$6 {σ}_{j} = \frac{q * f ( {x}_{j} )}{100}$$

$${σ}_{j} = \frac{q * f ( {x}_{j} )}{600} .$$

Simulation data (xⱼ, yⱼ) may then be used to augment the current experimental data, and the augmented dataset (D=D_{c} ∪{xⱼ, yⱼ}ⱼ₌₁^{J}) is used in the next step of the process, i.e., Step 108.

Further, the kernel matrix in Steps 108 and 110 may be updated by adding the noise variance in the diagonals which correspond to the noise variance q of the simulated data.

In some embodiments, there may be no data available from the current series of experiments D_{c}. In that case, simulation data {xⱼ, yⱼ}ⱼ₌₁^{J} and its noise measurement may be used as the inputs in Step 108.

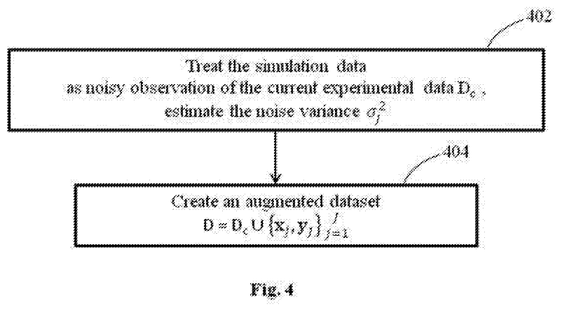

FIG. 4 is a flow diagram that illustrates an exemplary process of the Step 106 according to a third embodiment, in which a machine-based transfer learning process based on a difference function is applied to simulation data to generate predictive data.

As shown in FIG. 4, in Step 402, the process treats the simulated data as noisy observation of the current experimental data D_{c}, and estimates the noise variance €ⱼ accordingly. Next, in Step 404, an augmented dataset D=D_{c} ∪{xⱼ, yⱼ}ⱼ₌₁^{J} is created.

Further, in some embodiments, the past experimental data Dₚ and the simulated data Dₛ may both be available, in which case, the transfer learning process may be applied to both Dₚ and D_{c} respectively, creating an augmented dataset based on D_{c} and the transferred dataset of Dₚ and Dₛ.

Further, in some embodiments, the method may allow a user to choose the data to be used in the transfer learning process.

For example, the method may allow a user to choose to apply the transfer learning process to either past experimental data or simulated data. The method may also allow a user to apply the transfer learning process to both past experimental data and simulated data.

Estimation of the Behavior of the Product Making Process

Assuming that the behavior of the product making process ƒ is unknown, step 108 will estimate it using available training data, e.g., data in the augmented dataset from applying the transfer learning process. This may be done by a multitude of methods, including the Gaussian Process method, the Bayesian Neural Network method, and any other suitable method.

(A) Gaussian Process Method

Gaussian Process models express a “belief” over all possible objective functions as a prior (distribution) through a Gaussian process. As data is observed, the prior is updated to derive the posterior distribution, i.e., there is an infinite set of functions which can fit the training data, each with a certain non-zero probability. At each of the unexplored settings this posterior (set of functions) may predict an outcome. When using Gaussian Process models, the outcome is not a fixed function, but random variables over a common probability space.

Thus, functions encountered in industrial processes, forms of which are usually unknown, may be estimated using non-parametric approaches. Gaussian Process-based approaches offer non-parametric frameworks that can be used to estimate the function using a training data set, e.g., the augmented dataset D created in Step 106 as described above.

As mentioned above, given augmented input/output dataset D={x_{n*}, y_{n*}}_{n*=1}^{N*}, the behavior of the product making process may be modeled using the following Gaussian Process model: y_{n*}=ƒ(x_{n*})+€1 (where € is the measurement noise, and 1 denotes a vector having all its elements being one), and the d-th component of the function output y_{d} for any input x may be estimated as

E[y_{d}]=k^{T}K⁻¹vec(Y),var(y_{d})=k(x,x)−k_{T}K⁻¹k,

where Y may be a matrix stacking the output vectors y's for all the training data (n=1, . . . , N) as its rows. The function k may be an appropriate kernel function. Since y is a vector, the kernel function k may be computed by using a combination of a usual kernel function and an extra covariance function over multiple dimensions of y. The vector k contains the values of the kernel function k evaluated using x as the first argument and {x_{n*}}_{n*=1}^{N}* as the second argument. The matrix K denotes the kernel matrix, computed using kernel function k, for all pairs of {x_{n*}} in the training dataset. In summary, the above modeling enables us to estimate the output y given an input x.

Further, as described above, when using transfer learning to exploit past experimental data or simulated data, modification may be made in the function estimation by modifying the respective Gaussian process kernel matrix K.

In some embodiments, past experimental data may be transferred using a difference function as described above. The predicted uncertainties of g(xⱼ) (represented by co-variance σ₉²(x)) may be used to alter the kernel matrix in Steps 108 and 110, by modifying the respective Gaussian process kernel matrix K as

$$K + [ \begin{matrix}diag ( [ {σ}_{g 1}^{2} , … , {σ}_{gJ}^{2} ] ) & 0 \\ {0}^{T} & {σ}_{g}^{2} {I}_{N \times N}\end{matrix} ] .$$

In some other embodiments, past experimental data may be transferred as noisy observations of the current experimental process, as described above. The random noise (represented by variance σⱼ²) may be used to alter the kernel matrix in Steps 108 and 110, by modifying the respective Gaussian process kernel matrix K as

$$K + [ \begin{matrix}diag ( [ {σ}_{1}^{2} , … , {σ}_{J}^{2} ] ) & 0 \\ {0}^{T} & {σ}^{2} {I}_{N \times N}\end{matrix} ] .$$

In some other embodiments, simulation data simulated based on reference models may be exploited through the transfer learning step as described in above. The noise (represented by variance σⱼ²) may be used to alter the kernel matrix in Steps 108 and 110, by modifying the respective Gaussian process kernel matrix K as

$$K + [ \begin{matrix}diag ( [ {σ}_{1}^{2} , … , {σ}_{J}^{2} ] ) & 0 \\ {0}^{T} & {σ}^{2} {I}_{N \times N}\end{matrix} ] .$$

(B) Bayesian Neural Network Method

In some alternative embodiments, the functionality of the product making process ƒ may be estimated based on the available training data using a Bayesian Neural Network.

Given the input/output augmented dataset D={x_{n*}, y_{n*}}_{n*=1}^{N}*, the Bayesian Neural Network method trains a deep neural network to obtain a set of basis functions, parametrized by the weights and biases of the trained deep neural network. A Bayesian linear regressor may then be used in the output to capture the uncertainties in the weights. At unexplored settings x, the output y of the Bayesian neural network may be random variables with Gaussian distribution.

Recommendation of Next Experimental Setting

Next, values of the predicted function at unexplored settings are explored, and the one or more parameter values which lead to the value of the predicted function being such that the produced product will have improved characteristics is recommended to be used in making the product, e.g., in the next experiment.

As described above, the behavior of the product making process may be modeled using a Gaussian Process model, which places a prior over smooth functions and updates the prior using the input/output observations under a Bayesian framework. While modeling a function, the Gaussian process also estimates the uncertainties around the function values for every point in the input space. These uncertainties may be exploited to reach a desired value of the output.

The one or more of parameter values may be selected using a Bayesian optimisation process.

The Bayesian optimisation process involves finding a desired value for one or more elements of the outcome y of the current experiment, e.g., a maximum or a minimum value for some elements of y. Accordingly, a surrogate function (also referred to as an “acquisition function”) may be maximized or minimized. The surrogate function may be optimised in a multitude of ways. A surrogate optimisation strategy may be used to properly utilize both the mean and the variance of the predicted function values. Strategies differ on how they pursue two conflicting goals—“exploring” regions where predicted uncertainty is high, and “exploiting” regions where predicted mean values are high.

For example, the optimisation may be done via selecting an acquisition function which by definition takes high values where either some elements of the output of y is high or the uncertainty about y is high. In both cases, there is a reasonable chance to reach to higher output quality levels.

For Bayesian optimisation, a multitude of different acquisition functions are available, including probability of improvement over the current best, expected improvement over the current best, upper confidence bound (“GP-UCB”) criteria, predicted entropy search, etc.

For example, in one embodiment a probability of improvement acquisition function may be used.

Assume that among the experimental data recorded so far, the best output along d-th dimension (y_{best}) is achieved at input vector x_{best}, i.e., x_{best}=argmaxₓ_{_{n*}}ƒ^{d}(x_{n*}). The acquisition function may then be written as:

$${A}^{d} ( x ) = P ( {f}^{d} ( x ) > {f}^{d} ( {x}_{best} ) ) = Φ ( \frac{E [ {f}^{d} ( x ) ] - {f}^{d} ( {x}_{best} )}{var ( {f}^{d} ( x ) )} ) ,$$

where Φ is the cumulative distribution function for the Gaussian distribution with zero mean and standard deviation equal to one and the superscript d denotes the d-th dimension of the respective vectors.

The Bayesian optimisation maximizes the acquisition function A(x) formed using a combination of {A_{d}(x), ∀d} as

$${x}_{best} = \begin{matrix}argmax \\ x\end{matrix} A ( x ) , where {x}_{best} = [ \begin{matrix}{m}_{best} \\ {p}_{best}\end{matrix} ] .$$

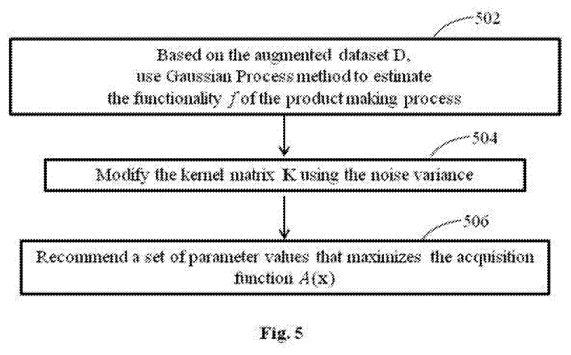

FIG. 5 is a flow diagram that illustrates an exemplary process of Step 108 using the Gaussian Process method.

As shown in FIG. 5, the behaviour ƒ of the product making process is estimated using the Gaussian Process method in Step 502, based on the augmented dataset D. The process then moves to Step 504, modifying the kernel matrix K using the noise variance. Next, in Step 506, one or more parameter values that maximizes the acquisition function A(x) are determined to be used in making the product.

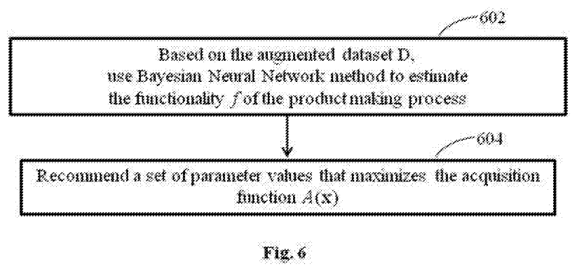

FIG. 6 is a flow diagram that illustrates another exemplary process of Step 108 using the Bayesian Neural Network method.

As shown in FIG. 6, the behavior ƒ of the product making process is estimated using the Bayesian Neural Network method in Step 602. The process then moves to Step 504, determining one or more parameter values that maximizes the acquisition function A(x) to be used in making the product.

Making the Product Using the Selected One or More Parameter Values

Returning to FIG. 1, after Step 110, the process then moves to Step 112, where the product is made using the one or more parameter values selected in Step 110.

In some embodiments, the selected one or more parameter values may be set by an automatic controller for controlling the manufacture of the product. This may be achieved by adopting a pre-programming PLC (Programmable logic controller), and connecting outputs of the PLC to devices used in the making of the product. The PLC may receive feedback from product testing devices.

In some other embodiments, the selected of parameter values may be manually set, e.g., by experimenters/plant operators. For example, for making short polymer fibres, an experimenter may manually set parameters such as pump settings and flow rates in a fluid-processing plant containing devices, through the use of analog or digital interfaces.

In some other embodiments, the parameter values may include characteristics of a raw material/product making device, including physical characteristics of a device such as dimensions and geometry, and may be manually set by the experimenter selecting a raw material/product making device. For example, for making fibres, a series of differently-shaped devices may be available to the experimenter, and the experimenter may manually set parameter values by choosing a device from the available range.

Referring back to FIG. 1, Steps 106-116 may be iterated until the whole or part of the made product exhibits one or more desired product characteristics.

In this way, by incorporating past knowledge and/or existing information, the desired product characteristics may be achieved with improved efficiency, as the number of required experiments may be reduced.

Throughout the iterations (current experiments), the behavior ƒ of the product making process may be updated. For example, the functionality ƒ of the product making process may be updated once every time when a new data pair {x, y} is obtained from an experiment. Alternatively, for example, the behavior ƒ of the product making process may be updated if a new data pair {x, y} is obtained from the experiment and the difference between the obtained value of y and the expected value of y is beyond a predetermined threshold.

Similarly, the functionality used in transfer learning, e.g., the difference function g(x) in transfer learning (a), may be updated throughout the current experiments to improve the accuracy of the transfer learning.

Further, the one or more parameter values that were used in making the whole or part of the product which exhibited the one or more desired product characteristics may be output, e.g., to be used in further making the product.

Further, as mentioned above, making the product includes making a tangible product, and includes making a simulation model of the product using simulation tools such as computer-based simulation software. Any computer-based simulation software that suits the type of product and provides the required simulation function may be adopted.

Further, as mentioned above, making or simulating of the product is not limited to making or simulating the whole product, but may also include partial making or simulation, which makes at least a part of the product, or simulates at least a part of the product with the selected one or more parameter values, based on which the product characteristics may be obtained, e.g., measured or calculated.

Accordingly, a method used in making a product, according to some embodiments, may include the following steps:
(a) applying a machine-based transfer learning process to prior result data, the application of the transfer learning process resulting in the generation of predictive data;
(b) selecting one or more parameter values to be used in making the product based on the generated predictive data;
(c) simulating the making of the whole or a part of the product using the selected one or more parameter values, and testing the product characteristic of the simulated whole or part of the product;
(d) iterating steps (a)-(c) until the whole or part of the simulated product exhibits one or more desired product characteristics;
(e) outputting the one or more parameter values that were used in simulating the whole or part of the product which exhibited the one or more desired product characteristics.

A whole or a part of the product may then be made using the output one or more parameter values.

For example, as mentioned before, the method according to embodiments of the present invention may be used to make a hull of a rowing shell, where:
elements of the input vector m may include the material type to be used in specific regions and its mechanical properties, e.g., density and stiffness;
the control parameters (elements of the vector p) may include the thickness and number of layers required and the direction the fibres will be oriented; and
elements of the product characteristic vector y may include quantitative assessment of the compliance (e.g., stiffness) of the hull structure, e.g., deflection at critical points on the structure and/or strains in specific regions.

In this case, transfer learning-based structural optimization may be conducted to achieve desired characteristics of the rowing shell, e.g., to achieve maximum stiffness at the prescribed minimum weight.

As making or simulating the whole rowing shell might be time-consuming and expensive, the transfer learning-based structural optimization may be conducted through partial simulation, e.g., adopting the following steps:
(a) applying a machine-based transfer learning process to prior result data based on previous simulations of at least a part of the rowing shell that includes the hull, and generating predictive data;
(b) based on the generated predictive data, selecting one or more parameter values to be used to simulate at least a part of the rowing shell that includes the hull;
(c) simulating a part of the rowing shell that includes the hull using the selected one or more parameter values, and testing the compliance of the partially simulated model;
(d) iterating steps (a)-(c) until the partially simulated model exhibits a desired compliance;
(e) outputting the one or more parameter values that were used in simulating the part of the rowing shell which exhibited the desired compliance.

The rowing shell may then be made using the optimized one or more parameter values, and its compliance and/or other product characteristics may further be tested.

Any suitable computer-based simulation software may be used in step (c) above, e.g., one that utilises Finite Element Analysis.

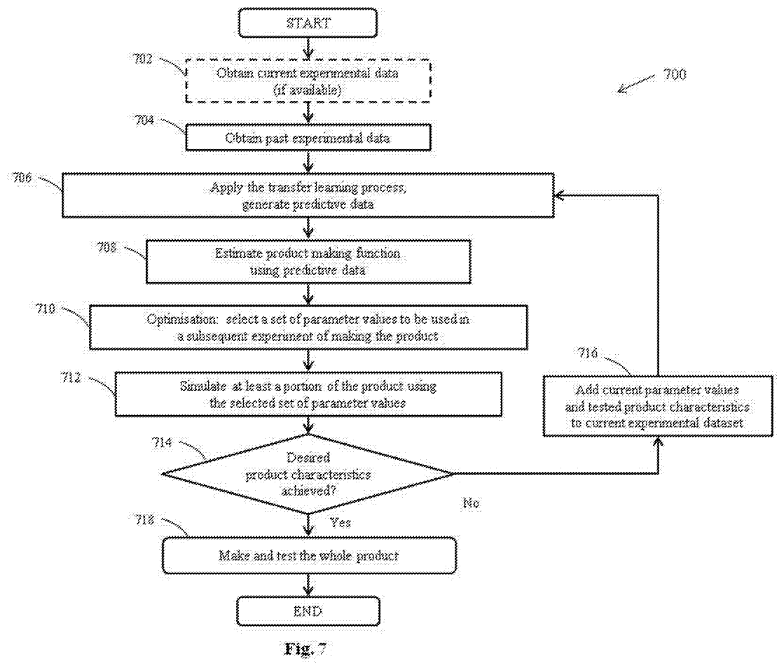

FIG. 7 illustrates an exemplary flow of the method according to the above embodiment.

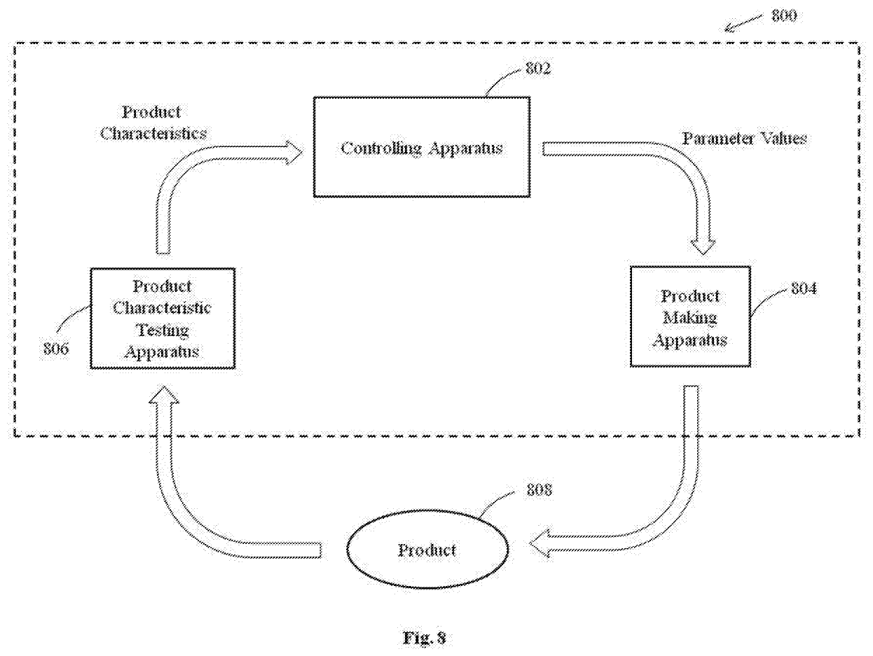

FIG. 8 is a block diagram that illustrates an exemplary product making system 800 implementing the method 100.

As shown in FIG. 8, the system 800 may include a controlling apparatus 802, a product making apparatus 804, and one or more product characteristic testing apparatus 806.

The controlling apparatus 802 applies the machine-based transfer learning process to prior result data, the application of the transfer learning process resulting in the generation of predictive data.

After the predictive data is generated, the controlling apparatus 802 selects one or more parameter values to be used in making the product based on the generated predictive data, and outputs the selected one or more parameter values to the product making apparatus 804.

When the product making apparatus 804 has received the selected one or more parameter values from the controlling apparatus 802, the product making apparatus 704 then makes or simulates the whole or a part of the product 808 using the selected one or more parameter values.

The product characteristic testing apparatus 806 tests the product characteristics of the whole or the part of the product 708 made or simulated by the product making apparatus 804, and sends the tested product characteristics to the controlling apparatus 802.

In some embodiments, the controlling apparatus 802 may use the tested product characteristics to recommend another set of parameter values. This process may be iterated until desired product characteristics are achieved.

As an example, for making fibers, the product making apparatus 804 may include a fluid chamber, devices to set process parameters, tubing, vessels, and temperature-controlling devices, and the product characteristic testing apparatus 706 may include a microscope, an image-evaluating software or a rheometer.

In another example, for making copolymers, the product making apparatus 804 may include reaction vessels, tubing, condensing systems, and the product characteristic testing apparatus 806 may include instruments such as a Nuclear Magnetic Resonance spectrometer or a Fourier Transform Infrared spectrometer, a rheometer, a melting point measurement apparatus, a gel permeation chromatography system and/or a UV-Visible spectrometer.

In another example, for making mixtures for dissolving minerals, the product making apparatus 804 may include a reaction vessel, volume measuring systems, a temperature controller, and the product characteristic testing apparatus 706 may include a set of samples of the target material to be dissolved, vessels to contain such samples and the mixture for their dissolution, a rheometer, a surface tension measurement system, and software to calculate Hansen solubility parameters.

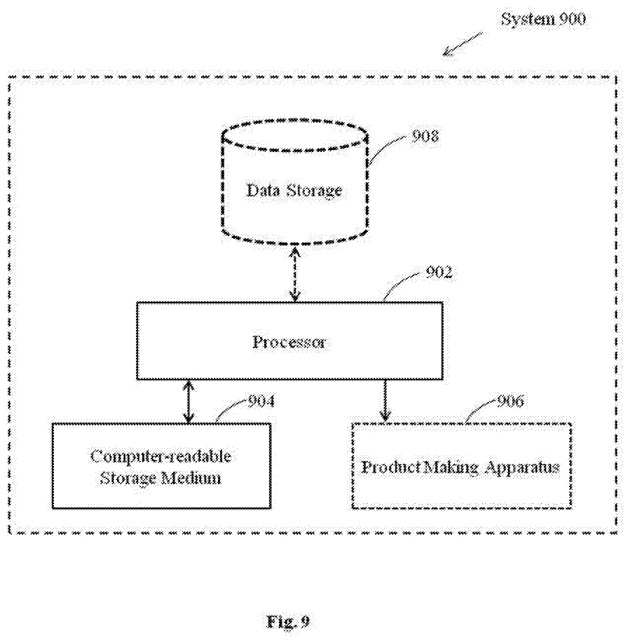

FIG. 9 illustrates a block diagram of a system used in making a product according to some embodiments of the above system.

As shown in FIG. 9, the system 900 includes at least one computer hardware processor 902 and at least one computer-readable storage medium 904.

The computer-readable storage medium 904 stories program instructions executable by the processor 902 to:
(a) apply a machine-based transfer learning process to prior result data, the application of the transfer learning process resulting in the generation of predictive data;
(b) select one or more parameter values to be used in making or simulating the making of the whole or a part of the product based on the generated predictive data; and
(c) output the selected one or more parameter values.

The system 900 may further include a product making apparatus 906.

The product making apparatus 906 receives the one or more output parameter values from the processor, and makes or simulates the making of the whole or a part of the product using the selected one or more parameter values.

Further, when the product making apparatus 906 makes the product using the selected one or more parameter values, the product making apparatus may make or simulate the making, of a sample of the product.

Further, when the product making apparatus 906 makes or simulates the making of a sample of the product, the product making apparatus may make or simulate the making of at least a part of the product.

The system 900 may further include a data storage component 908, which stores the prior result data.

The computer-readable storage medium may include an installation medium, e.g., Compact Disc Read Only Memories (CD-ROMs), a computer system memory such as Dynamic Random Access Memory (DRAM), Static Random Access Memory (SRAM), Extended Data Out Random Access Memory (EDO RAM), Double Data Rate Random Access Memory (DDR RAM), Rambus Dynamic Random Access Memory (RDRAM), etc., or a non-volatile memory such as a magnetic media, e.g., a hard drive, or optical storage. The computer-readable storage medium may also include other types of memory or combinations thereof.

In addition, the computer-readable storage medium 904 may be located in a different device from the processor 902.

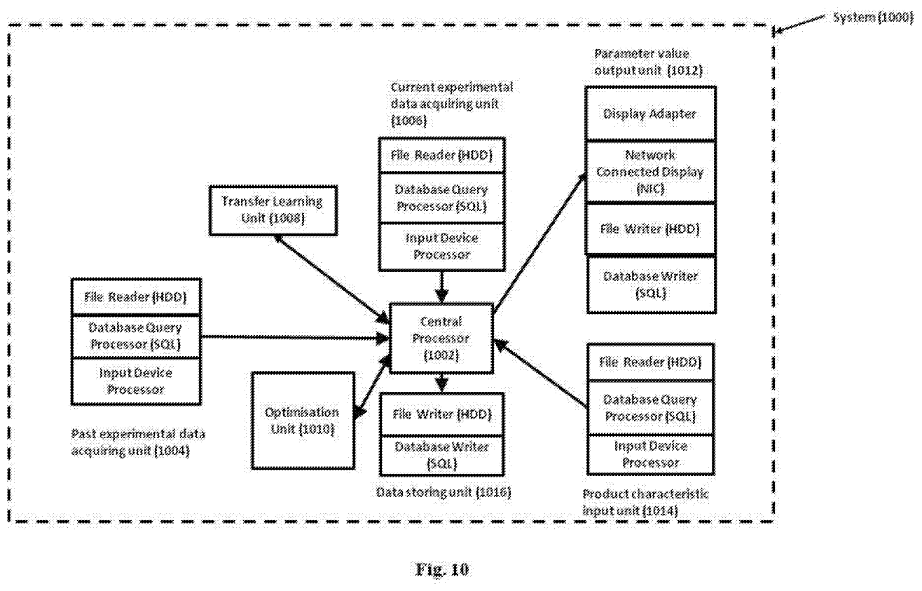

FIG. 10 illustrates another example of the system used in making a product, according to some other embodiments.

As shown in FIG. 10, the system 1000 includes a central processor 1002, transfer learning unit 1008 and an optimisation unit 1010.

The system 1000 further includes a past experimental data acquiring unit 1004, which obtains past experimental data. The past experimental data may be obtained by the past experimental data acquiring unit 1004 from any suitable source, e.g., from a set of files, a database of records, or by inputs (e.g., filling up a table) on a website or through an application installed on a mobile terminal device.

The system 1000 may further includes a current experimental data acquiring unit 1006, which obtains current experimental data (if it exists).

When the central processor 1002 receives the past and current experimental data from the past experimental data acquiring unit 1004 and the current experimental data acquiring unit 1006, the central processor 1002 controls the transfer learning unit 1008 to apply a transfer learning process to the received data to generate predictive data, and then controls the optimisation unit 1010 to select one or more parameter values to be used in making the product.

Each of the transfer learning unit 1008 and the optimisation unit 1010 may reside either locally, or on a remote server and connected to the central processor 1002 via an interface or communication network.

The central processor 1002 then sends the selected one or more parameter values to the parameter value output unit 1012 to be output. The output of the selected parameter values may be made by any suitable methods, including displaying the values on a local/remote screen, or by writing to a file or a database.

The made product may then be tested, where the obtained product characteristics may be input into the system 1000 through the product characteristic input unit 1014.

The central processor 1002 may decide whether one or more desired product characteristics have been achieved. If not, the central processor 1002 may control the transfer learning unit 1008 and the optimisation unit 1010 to conduct another iteration.

All the data obtained may be stored in a data storing unit 1016. The data storing unit 1016 includes permanent storage that uses a File Writer or a Database Writer, and also includes output interface for storing the data in external data storage.

As shown in FIG. 10, some of the above blocks may use a multitude of resources, e.g., HDD reader, HDD writer, Database Query Processor (SQL), Database writer (SQL), Display adapter, NIC card, Input processor (keyboard, pointing device, touch interface, voice recognizer). The resources may be shared in the system 1000.

For example, the past experimental data acquiring unit 1004, the current experimental data acquiring unit 1006 and the data storing unit 1016 may share the same resources.

The system 1000 may further includes other input and/or output units, such as a user interface unit for receiving user instruction and display information to the user. For example, the user may be provided with information from the system 1000 by way of monitor, and may interact with the system 1000 through I/O devices, e.g., a keyboard, a mouse, or a touch screen.

Experimental Results

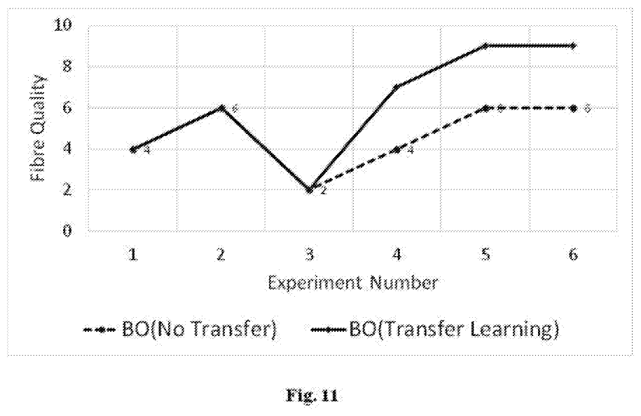

FIG. 11 shows the experimental results of a first exemplary experiment in which the product making method 100 is applied to making short nano-fibres.

The first exemplary experiment involved a process of making short nano-fibres using a fibre forming apparatus of the type described in WO2014134668A1 (PCT/AU 2014/000204).

The fibre forming apparatus comprises a flow circuit, through which a dispersion medium, such as a solvent, circulates. The flow circuit includes three fluidly connected units, including a solvent tank, pump arrangement and a flow device.

The solvent tank is a tank in which a volume of the selected dispersion medium is collected, prior to feeding through the flow circuit. The inlet to a pump arrangement is fluidly connected to the solvent tank.

The pump arrangement pumps the dispersion medium into a fluidly connected flow device. Fibres are formed in the flow device. The dispersion medium, with fibres therein, may flow through to an empty tank for direct collection, or to the solvent tank where the dispersion medium can be recirculated through the flow circuit. The generated fibres can be extracted prior to or from the solvent tank using any number of standard solid-liquid separation techniques.

In the first exemplary experiment, the random co-polymer Poly (ethylene-co-acrylic acid) (e.g., PEAA, Primacor 59901, Dow) is dissolved or dispersed in a suitable medium (e.g., ammonium hydroxide ˜2.5% vol in deionized water) and is mixed with the flowing solvent 1-butanol (dispersant) inside the flow device, as described in WO2013056312 A1 and WO 2014134668 A1. The quality and yield of fibres that can be produced, as well as their size and homogeneity, are affected by both the polymer and the solvent flow rates. Other undesirable by-products such as spheres and debris can be produced that reduce the quality of the product and are also dependent on flow rates.

The product characteristics include homogeneity in length and diameter, diameter distribution, absence of spheres and debris and overall quality.

The parameter values include composition of fluid flows, relative and absolute speeds of fluids, temperature, device geometry, rheology of fluids, and solubility ratios.

The aim is to find a combination of polymer and solvent flow rates that results in the production of high quality fibres.

In this example, the transfer learning process is applied through comparing a first group of the prior parameter values and the corresponding prior product characteristics (past experimental data) with a second group of the prior parameter values and the corresponding prior product characteristics (current experimental data). In particular, the two groups of data are compared by learning and refining a difference function between the past experimental data and the current experimental data.

In this example, the past experimental data comes from the experimental production of short fibres using a straight channel device. Fibre quality measurements were taken at 9 different flow rate combinations.

The current experiment, from which the current experimental data is obtained, has both the same polymer and solvent, but a new device is trialed that has a concave shaped channel. Despite the different shapes of the channels, the basic behaviour of fibre forming is expected to be similar for both the devices.

Bayesian optimization is used to select one or more parameter values to be used in the next iteration of making the fibre.

To test the effect of using the transfer learning process, two series of experiments were conducted. One used Bayesian optimization with transfer learning based on the past experimental data, and the second used Bayesian optimization without adopting transfer learning.

The results of these two series of experiments are shown by “BO (No Transfer)” and “BO (Transfer Learning)” respectively in FIG. 11.

FIG. 11 shows the overall fibre quality achieved in each iteration during the Bayesian optimization, and “the experiment number” indicates the number of iterations.

As shown in FIG. 11, from the fourth iteration, a higher overall fiber quality is achieved within the same number of iterations by adopting an embodiment of the invention. Further, at the end of each optimization, the series of experiments guided by an embodiment of the present invention achieves a higher overall fiber quality than the series of experiments without the guidance.

Some of the past experimental data that was used is provided in Table 1 below, including the solvent flow rate, polymer flow rate and the overall quality. The range of the two flow rates were [10 mL/hr, 150 mL/hr] and [100 mL/hr, 1500 mL/hr], respectively. The overall quality was evaluated using a scale of 1 to 10, with 1 representing the lowest quality and 10 representing the highest quality. The desired quality was set to be 9 or above.

TABLE 1
(Data from the past experiment)

| Solvent flow rate | Polymer flow rate | |
|---|---|---|
| (mL/hr) | (mL/min) | Overall Quality |
| 30 | 200 | 6 |
| 60 | 500 | 4 |
| 20 | 160 | 5 |
| 40 | 200 | 4 |
| 10 | 700 | 1 |
| 150 | 1500 | 7 |
| 150 | 1400 | 8 |
| 140 | 1400 | 9 |
| 140 | 1300 | 9 |

Some initial parameters in the current experiment were generated randomly, including the solvent flow rate, polymer flow rate and the overall quality, and are shown in Table 2 below. The initial data is also shown in FIG. 11 with Experiment Numbers 1-3.

TABLE 2
(Initial data from the current experiment)

| Solvent flow rate | Polymer flow rate | |
|---|---|---|
| (mL/hr) | (mL/min) | Overall Quality |
| 15 | 300 | 4 |
| 30 | 600 | 6 |
| 30 | 500 | 2 |

Using an embodiment of the present invention, a predictive dataset was generated based on the past experimental data, as shown in Table 3 below:

TABLE 3
(Predictive dataset generated by the transfer learning process)

| Solvent flow rate | Polymer flow rate | Overall Quality |
|---|---|---|
| (mL/hr) | (mL/min) | (Predicted) |
| 30 | 200 | 5.54 |
| 60 | 500 | 4.01 |
| 20 | 160 | 4.47 |
| 40 | 200 | 3.64 |
| 10 | 700 | 2.22 |
| 150 | 1500 | 7 |
| 150 | 1400 | 8 |
| 140 | 1400 | 9 |
| 140 | 1300 | 9 |

In this application of an embodiment of the present invention, a difference function g(x) was estimated based on the past experimental data (shown in Table 1) and the initial data from the current experiment (shown in Table 2). The difference function g(x) was modeled using a Gaussian process. A Gaussian process can be specified by three components: a covariance function, a Kernel matrix and the observed data. In the difference function g(x), the covariance function was

k_{g}(x₁,x₂)=exp(−∥x₁./[150 1500]−x₂./[150 1500]∥²₂/0.06),

the Kernel matrix was

$${K}_{g} = [ \begin{matrix}1.452 & 0.435 & 0.629 \\ 0.435 & 1.685 & 0.929 \\ 0.629 & 0.929 & 1.696\end{matrix} ] ,$$

and the observed data was

$$( X = [ \begin{matrix}15 & 300 \\ 30 & 600 \\ 30 & 500\end{matrix} ] , y = [ \begin{matrix}0.575 \\ - 4.184 \\ 0.857\end{matrix} ] ) .$$

The difference function g(x) was applied to the results of the past experiments (at parameters for which no current experiments had been undertaken) to generate predictive data (illustrated in Table 3).

This predictive data was used in combination with the current experimental data to build an augmented dataset, illustrated in Table 4 below.

TABLE 4
(Augmented dataset)

| x* = [Solvent flow rate (mL/hr) | y* = Overall |
|---|---|
| Polymer flow rate (mL/min)] | Quality |
| x₁* = [10 700] | y₁* = 2.22 |
| x₂* = [15 300] | y₂* = 4 |
| x₃* = [20 160] | y₃* = 4.47 |
| x₄* = [30 500] | y₄* = 2 |
| x₅* = [30 200] | y₅* = 5.54 |
| x₆* = [30 600] | y₆* = 6 |
| x₇* = [40 200] | y₇* = 3.64 |
| x₈* = [60 500] | y₈* = 4.01 |
| x₉* = [140 1300] | y₉* = 9 |
| x₁₀* = [140 1400] | y₁₀* = 9 |
| x₁₁* = [150 1400] | y₁₁* = 8 |
| x₁₂* = [150 1500] | y₁₂* = 7 |

This augmented dataset was then used to estimate a Gaussian Process model for modeling the product making process, in which the covariance function k was

k(x₁,x₂)=exp(−∥x₁./[150 1500]−x₂./[150 1500]∥²₂/0.06),

and the kernel matrix K was

| | | | | | | | | | | | |
|---|---|---|---|---|---|---|---|---|---|---|---|
| 2.254 | 0.004 | 0.918 | 0.929 | 0.117 | 0.000 | 0.000 | 0.000 | 0.000 | 0.786 | 0.306 | 0.513 |
| 0.004 | 2.701 | 0.002 | 0.006 | 0.002 | 0.000 | 0.000 | 0.000 | 0.000 | 0.003 | 0.007 | 0.008 |
| 0.918 | 0.002 | 2.202 | 0.735 | 0.107 | 0.000 | 0.000 | 0.000 | 0.000 | 0.849 | 0.221 | 0.394 |
| 0.929 | 0.006 | 0.735 | 2.430 | 0.081 | 0.000 | 0.000 | 0.000 | 0.000 | 0.584 | 0.284 | 0.477 |
| 0.117 | 0.002 | 0.107 | 0.081 | 2.389 | 0.000 | 0.000 | 0.000 | 0.000 | 0.300 | 0.690 | 0.553 |
| 0.000 | 0.000 | 0.000 | 0.000 | 0.000 | 2.701 | 0.929 | 0.862 | 0.690 | 0.000 | 0.000 | 0.000 |
| 0.000 | 0.000 | 0.000 | 0.000 | 0.000 | 0.929 | 2.701 | 0.929 | 0.862 | 0.000 | 0.000 | 0.000 |
| 0.000 | 0.000 | 0.000 | 0.000 | 0.000 | 0.862 | 0.929 | 2.701 | 0.929 | 0.000 | 0.000 | 0.000 |
| 0.000 | 0.000 | 0.000 | 0.000 | 0.000 | 0.690 | 0.862 | 0.929 | 2.701 | 0.000 | 0.000 | 0.000 |
| 0.786 | 0.003 | 0.849 | 0.584 | 0.300 | 0.000 | 0.000 | 0.000 | 0.000 | 1.090 | 0.435 | 0.629 |
| 0.306 | 0.007 | 0.221 | 0.284 | 0.690 | 0.000 | 0.000 | 0.000 | 0.000 | 0.435 | 1.090 | 0.929 |
| 0.513 | 0.008 | 0.394 | 0.477 | 0.553 | 0.000 | 0.000 | 0.000 | 0.000 | 0.629 | 0.929 | 1.090 |

This kernel matrix K of size (12×12) was computed using the covariance function and all the pairwise data from Table 4.

Using this aggregated data a new experimental setting (a set of parameter values) was recommended, where the expected improvement over the previous best output was the highest (as shown in Table 4, the previous best output of the overall quality was 9).

In particular, a mean function μ(x)=k^{T}K⁻¹y* and an uncertainty function σ(x)=1−k^{T}K⁻¹k was defined, where

k=[k(x,x*₁), . . . ,k(x,x*₁₂)],y*=[y*₁, . . . ,y*₁₂].

Given these functions, the expected improvement at an experimental setting x was computed as El(x)=(μ(x)−9)ψ(Z)+σ(x)ϕ(Z) if σ(x)>0 and El(x)=0 otherwise. The symbol Z denotes normalized improvement defined as

$$Z = \frac{μ ( x ) - 9}{σ ( x )} ,$$

and the symbols Φ and ϕ denote the cumulative distribution function and probability density function of the standard normal distribution respectively.

The expected improvement function El(x) computed using the augmented data of Table 4 was maximized, and its maximum was recommended as the next experimental setting, i.e., what was recommended was

$${x}_{best} = {argmax}_{x} EI ( x )$$

where

$$EI ( x ) = ( {[ k ( x , {x}_{1}^{*} ) , … , k ( x , {x}_{12}^{*} ) ]}^{T} {K}^{- 1} {y}^{*} - 9 ) Φ ( \frac{{[ k ( x , {x}_{1}^{*} ) , … , k ( x , {x}_{12}^{*} ) ]}^{T} {K}^{- 1} {y}^{*} - 9}{1 - {[ k ( x , {x}_{1}^{*} ) , … , k ( x , {x}_{12}^{*} ) ]}^{T} {K}^{- 1} [ k ( x , {x}_{1}^{*} ) , … , k ( x , {x}_{12}^{*} ) ]} ) + ( 1 - {[ k ( x , {x}_{1}^{*} ) , … , k ( x , {x}_{12}^{*} ) ]}^{T} {K}^{- 1} [ k ( x , {x}_{1}^{*} ) , … , k ( x , {x}_{12}^{*} ) ] ) φ ( \frac{{[ k ( x , {x}_{1}^{*} ) , … , k ( x , {x}_{12}^{*} ) ]}^{T} {K}^{- 1} {y}^{*} - 9}{1 - {[ k ( x , {x}_{1}^{*} ) , … , k ( x , {x}_{12}^{*} ) ]}^{T} {K}^{- 1} [ k ( x , {x}_{1}^{*} ) , … , k ( x , {x}_{12}^{*} ) ]} ) if 1 - {[ k ( x , {x}_{1}^{*} ) , … , k ( x , {x}_{12}^{*} ) ]}^{T} {K}^{- 1} [ k ( x , {x}_{1}^{*} ) , … , k ( x , {x}_{12}^{*} ) ] > 0 , and EI ( x ) = 0 otherwise .$$

In this iteration, the recommended parameter values were [solvent flow rate=140 mL/hr, polymer flow rate=1400 mL/hr].

An experiment was then performed at this setting, and the corresponding product characteristic (overall quality) was tested to be 7. The recommended parameter values and the corresponding product characteristic ([solvent flow rate=140 mL/hr, polymer flow rate=1400 mL/hr], [overall quality=7]) was then added to the current experimental data. The updated current experimental data is as shown in Table 5 below. This result is shown in FIG. 11 as Experiment Number 4.

TABLE 5
(Updated data from the current experiment)

| Solvent flow rate | Polymer flow rate | |
|---|---|---|
| (mL/hr) | (mL/min) | Overall Quality |
| 15 | 300 | 4 |
| 30 | 600 | 6 |
| 30 | 500 | 2 |
| 140 | 1400 | 7 |

The difference function g(x) was then updated using data from Table 5. The updated g(x) had the covariance function as

k_{g}(x₁,x₂)=exp(−∥x₁./[150 1500]−x₂./[150 1500]∥²₂/0.06),

the Kernel matrix as

$${K}_{g} = [ \begin{matrix}1.452 & 0.435 & 0.629 & 0.000 \\ 0.435 & 1.685 & 0.929 & 0.000 \\ 0.629 & 0.929 & 1.696 & 0.000 \\ 0.000 & 0.000 & 0.000 & 1.224\end{matrix} ] ,$$

and the observed data as

$$( X = [ \begin{matrix}15 & 300 \\ 30 & 600 \\ 30 & 500 \\ 140 & 1400\end{matrix} ] , y = [ \begin{matrix}0.575 \\ - 4.184 \\ 0.857 \\ 1.612\end{matrix} ] ) .$$

Next, the predictive dataset was updated using the updated difference function g(x), as shown in Table 6 below. Although the overall quality obtained from experiment is within the scale 1 to 10, the predicted overall quality in the predictive dataset, which is calculated using g(x), may be lower than 1, and may have a negative value.

TABLE 6
(Updated predictive dataset generated
by the transfer learning process)

| Solvent flow rate | Polymer flow rate | Overall Quality |
|---|---|---|
| (mL/hr) | (mL/min) | (Predicted) |
| 30 | 200 | 2.75 |
| 60 | 500 | 3.96 |
| 20 | 160 | 4.83 |
| 40 | 200 | −0.79 |
| 10 | 700 | 8.70 |
| 150 | 1500 | 5.60 |
| 150 | 1400 | 6.50 |
| 140 | 1400 | 7.39 |
| 140 | 1300 | 7.50 |

This predictive data is used in combination with the current experimental data to update the augmented dataset, illustrated in Table 7 below.

TABLE 7
(Updated augmented dataset)

| x* = [Solvent flow rate (mL/hr) | y* = Overall |
|---|---|
| Polymer flow rate (mL/min)] | Quality |
| x₁* = [10 700] | y₁* = 8.70 |
| x₂* = [15 300] | y₂* = 4 |
| x₃* = [20 160] | y₃* = 4.83 |
| x₄* = [30 500] | y₄* = 2 |
| x₅* = [30 200] | y₅* = 2.75 |
| x₆* = [30 600] | y₆* = 6 |
| x₇* = [40 200] | y₇* = −0.79 |
| x₈* = [60 500] | y₈* = 3.96 |
| x₉* = [140 1300] | y₉* = 7.5 |
| x₁₀* = [140 1400] | y₁₀* = 7 |
| x₁₁* = [150 1400] | y₁₁* = 7.39 |
| x₁₂* = [150 1500] | y₁₂* = 6.5 |
| x₁₃* = [150 1500] | y₁₃* = 5.6 |

Using this updated augmented dataset, the kernel matrix K of the Gaussian Process model for modeling the product making process was updated as

| | | | | | | | | | | | | |
|---|---|---|---|---|---|---|---|---|---|---|---|---|
| 1.090 | 0.004 | 0.918 | 0.929 | 0.117 | 0.000 | 0.000 | 0.000 | 0.000 | 0.786 | 0.306 | 0.513 | 0.000 |
| 0.004 | 1.090 | 0.002 | 0.006 | 0.002 | 0.000 | 0.000 | 0.000 | 0.000 | 0.003 | 0.007 | 0.008 | 0.000 |
| 0.918 | 0.002 | 1.090 | 0.735 | 0.107 | 0.000 | 0.000 | 0.000 | 0.000 | 0.849 | 0.221 | 0.394 | 0.000 |
| 0.929 | 0.006 | 0.735 | 1.090 | 0.081 | 0.000 | 0.000 | 0.000 | 0.000 | 0.585 | 0.284 | 0.477 | 0.000 |
| 0.117 | 0.002 | 0.107 | 0.081 | 1.090 | 0.000 | 0.000 | 0.000 | 0.000 | 0.300 | 0.691 | 0.553 | 0.000 |
| 0.000 | 0.000 | 0.000 | 0.000 | 0.000 | 1.090 | 0.929 | 0.862 | 0.691 | 0.000 | 0.000 | 0.000 | 0.862 |
| 0.000 | 0.000 | 0.000 | 0.000 | 0.000 | 0.929 | 1.090 | 0.929 | 0.862 | 0.000 | 0.000 | 0.000 | 0.929 |
| 0.000 | 0.000 | 0.000 | 0.000 | 0.000 | 0.862 | 0.929 | 1.090 | 0.929 | 0.000 | 0.000 | 0.000 | 1.000 |
| 0.000 | 0.000 | 0.000 | 0.000 | 0.000 | 0.691 | 0.862 | 0.929 | 1.090 | 0.000 | 0.000 | 0.000 | 0.929 |
| 0.786 | 0.003 | 0.849 | 0.585 | 0.300 | 0.000 | 0.000 | 0.000 | 0.000 | 1.090 | 0.435 | 0.629 | 0.000 |
| 0.306 | 0.007 | 0.221 | 0.284 | 0.691 | 0.000 | 0.000 | 0.000 | 0.000 | 0.435 | 1.090 | 0.929 | 0.000 |
| 0.513 | 0.008 | 0.394 | 0.477 | 0.553 | 0.000 | 0.000 | 0.000 | 0.000 | 0.629 | 0.929 | 1.090 | 0.000 |
| 0.000 | 0.000 | 0.000 | 0.000 | 0.000 | 0.862 | 0.929 | 1.000 | 0.929 | 0.000 | 0.000 | 0.000 | 1.090 |

Using this updated Gaussian Process model for modeling the product making process and the updated augmented dataset, a new experimental setting (a set of parameter values) was recommended, where the expected improvement over the previous best output was the highest.

In particular, an updated mean function μ(x)=k^{T}K⁻¹y* and an updated uncertainty function σ(x)=1−k^{T}K⁻¹k was defined where k=[k(x, x*₁), . . . , k(x, x*₁₃)], y*=[y*₁, . . . , y*₁₃].

Given these functions, the expected improvement at an experimental setting x was computed as El(x)=(μ(x)−8.7)Φ(Z)+σ(x)ϕ(Z) if σ(x)>0 and El(x)=0 otherwise. The symbol Z denotes normalized improvement defined as

$$Z = \frac{μ ( x ) - 8.7}{σ ( x )} ,$$

and the symbols Φ and ϕ denote the cumulative distribution function and probability density function of the standard normal distribution respectively.

The expected improvement function computed using the updated augmented dataset of Table 7 was maximized and its maximum was recommended as the next experimental setting, i.e., what was recommended was

$${x}_{best} = {argmax}_{x} EI ( x )$$

where

$$EI ( x ) = ( {[ k ( x , {x}_{1}^{*} ) , … , k ( x , {x}_{13}^{*} ) ]}^{T} {K}^{- 1} {y}^{*} - 8.7 ) Φ ( \frac{{[ k ( x , {x}_{1}^{*} ) , … , k ( x , {x}_{13}^{*} ) ]}^{T} {K}^{- 1} {y}^{*} - 8.7}{1 - {[ k ( x , {x}_{1}^{*} ) , … , k ( x , {x}_{13}^{*} ) ]}^{T} {K}^{- 1} [ k ( x , {x}_{1}^{*} ) , … , k ( x , {x}_{13}^{*} ) ]} ) + ( 1 - {[ k ( x , {x}_{1}^{*} ) , … , k ( x , {x}_{13}^{*} ) ]}^{T} {K}^{- 1} [ k ( x , {x}_{1}^{*} ) , … , k ( x , {x}_{13}^{*} ) ] ) φ ( \frac{{[ k ( x , {x}_{1}^{*} ) , … , k ( x , {x}_{13}^{*} ) ]}^{T} {K}^{- 1} {y}^{*} - 8.7}{1 - {[ k ( x , {x}_{1}^{*} ) , … , k ( x , {x}_{13}^{*} ) ]}^{T} {K}^{- 1} [ k ( x , {x}_{1}^{*} ) , … , k ( x , {x}_{13}^{*} ) ]} ) if 1 - {[ k ( x , {x}_{1}^{*} ) , … , k ( x , {x}_{13}^{*} ) ]}^{T} {K}^{- 1} [ k ( x , {x}_{1}^{*} ) , … , k ( x , {x}_{13}^{*} ) ] > 0 and EI ( x ) = 0 otherwise .$$

In this iteration, the recommended parameter values are [solvent flow rate=150 mL/hr, polymer flow rate=1400 mL/hr].

Another experiment (Experiment Number 5) was then performed at this setting, and the corresponding product characteristic (overall quality) was tested to be 9. The recommended parameter values and the corresponding product characteristic ([solvent flow rate=150 mL/hr, polymer flow rate=1400 mL/hr], [overall quality=9]) was then added to the current experimental data.

The above process was further iterated once more, as shown in FIG. 11 as Experiment Number 6.

In Experiment Number 6, the product characteristic (overall quality) remained the same as the previous iteration (Experiment Number 5), and the experiment ended accordingly.

As shown in FIG. 11, the efficiency of achieving an optimum product quality was improved in the experiments using the an embodiment of the present invention, e.g., BO (Transfer Learning) achieved an overall quality of 7 in Experiment Number 4, while BO (No transfer) did not achieve this quality in any of the 5 experiments. Further, after the same number of iterations (six iterations), BO (Transfer Learning) achieved a higher overall quality than BO (No transfer).

A second exemplary experiment involved the same process of making short nano-fibers, except silk fibroin solution was mixed with the polymer solution.

The rheological properties of the two solutions are markedly different, and typically they result in significantly different outcomes of the fibre production experiments [as described in WO2013056312 A1 and WO 2014134668 A1. Nonetheless, it is expected that mixing small amounts of silk solution into the PEAA solution may result in slightly-changed rheological properties (e.g., within 30% of the initial values) and fibre-formation outcomes. The silk solution is prepared by dissolving 10% w/vol degummed silk either in a LiBr (9.2M) solution or in a CaCl₂)-Ethanol-Water solution (molar ratio 1:2:8) and stirring for four hours at 98° C. or at 75° C. respectively. Following dialysis and concentration, the silk solution, in concentration of about 6% w to about 30% w, is mixed in a 1:9 volume proportion (silk solution:PEAA solution) and used for fiber production in the same manner as in the first exemplary experiment.

The second exemplary experiment tests the efficacy of knowledge transfer protocols integrated in experimental optimization, in a transfer learning capacity. In this example, two materials with different fibre-forming characteristics are mixed and prior knowledge on only one of the two materials is used to implement the experiment optimisation exercise. No knowledge on the “dopant” behaviour in fibre forming system is used for the optimisation.

The parameters applied to this exemplary experiment are the same as those of the first exemplary experiment with the exception of the proportion of silk solution used in the polymer solution mixture.

The product characteristics include homogeneity in length and diameter, diameter distribution, absence of spheres and debris, and overall quality. These characteristics are similar to those related to the first exemplary experiment.

In this example, the product characteristics are expected to be affected by the polymer and solvent flow rates, and by the proportion of silk and PEAA polymer solutions.

The aim of the experiment is to find a combination of flow rates (polymer and dispersant) that results in the production of fibers with higher quality than at the start of the process.

In this example, the transfer learning process is applied through comparing a first group of the prior parameter values and corresponding prior product characteristics (past experimental data) with a second group of the prior parameter values and corresponding prior product characteristics (current experimental data). In particular, the two groups of data are compared by learning and refining a difference function between the past experimental data and the current experimental data.

In this example, the past experimental data comes from the experimental production of short fibres using a single polymer solution (PEAA). Fiber quality measurements were taken at 9 different flow rate combinations.

The current experiment, from which the current experimental data is obtained, has the same solvent and uses the same device, except a 1:9 vol mixture of silk fibroin and PEAA solutions is used instead of a plain PEAA solution. Despite the polymer mixture used, the fundamental behaviour in fibre formation experiments is expected to be similar for both experiments.

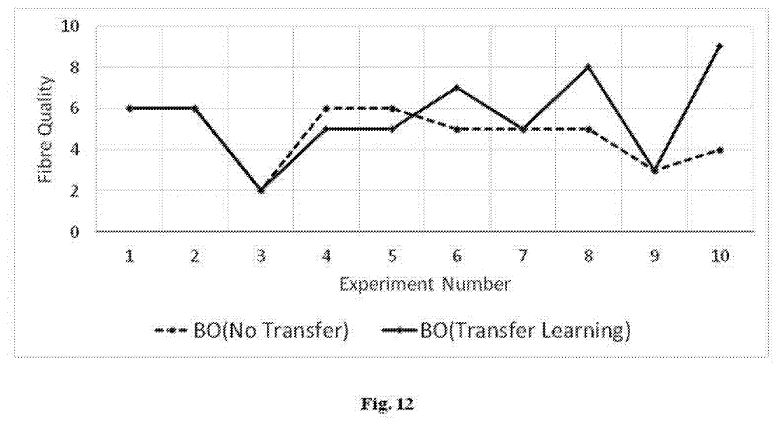

The results of these two series of experiments are shown by “BO (No Transfer)” and “BO (Transfer Learning)” respectively in FIG. 12.

FIG. 12 shows the overall fibre quality achieved in each iteration during the Bayesian optimization, and “the experiment number” indicates the number of iterations.

As shown in FIG. 12, the series of experiments guided by an embodiment of the present invention achieves a higher overall fiber quality than the series of experiments without the guidance.

The past experimental data that was used is provided in Table 8 below, including the solvent flow rate, polymer flow rate and the overall quality. The range of the two flow rates are [10 mL/hr, 150 mL/hr] and [100 mL/hr, 1500 mL/hr], respectively. The overall quality is evaluated using a scale of 1 to 10, with 1 representing the lowest quality and 10 representing the highest quality. The desired quality is 9 or above.

TABLE 8
(Data from the past experiment)

| Solvent flow rate | Polymer flow rate | |
|---|---|---|
| (mL/hr) | (mL/min) | Overall Quality |
| 15 | 300 | 4 |
| 20 | 700 | 4 |
| 30 | 500 | 2 |
| 30 | 600 | 6 |
| 60 | 600 | 6 |
| 70 | 800 | 6 |
| 140 | 1400 | 7 |
| 150 | 1300 | 9 |
| 150 | 1400 | 9 |

Some initial parameters in the current experiment were generated randomly, including the solvent flow rate and polymer flow rate. The overall quality of the fibers produced by these experiments is shown in Table 9 below. The initial data is also shown in FIG. 12 with Experiment Numbers 1-3.

TABLE 9
(Initial data from the current experiment)

| Solvent flow rate | Polymer flow rate | |
|---|---|---|
| (mL/hr) | (mL/min) | Overall Quality |
| 20 | 400 | 2 |
| 60 | 100 | 6 |
| 120 | 100 | 6 |

Using the updated Gaussian Process model as in the first exemplary experiment a new experimental setting (a set of parameter values) was recommended, where the expected improvement over the previous best output was the highest. In the first iteration, the recommended parameter values were [solvent flow rate=150 mL/hr, polymer flow rate=1400 mL/hr].

An experiment was then performed at this setting, and the corresponding product characteristic (overall quality) was tested to be 5. The recommended parameter values and the corresponding product characteristic ([solvent flow rate=140 mL/hr, polymer flow rate=1400 mL/hr], [overall quality=7]) was then added to the current experimental data. The iterative process was repeated 7 times, in the same way as detailed in the first exemplary experiment.

As shown in FIG. 12, the optimum product quality was achieved in the second exemplary experiment using the an embodiment of the present invention, e.g., BO (Transfer Learning) has achieved an overall quality of 9 in Experiment Number 10, while BO (No Transfer) did not achieve quality higher than 6 in any of the 7 iterations.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Many modifications will be apparent to those skilled in the art without departing from the scope of the present invention as hereinbefore described with reference to the accompanying drawings.

1. A method used in making a product, wherein a characteristic of the product is at least in part determined by values of parameters used in making the product, the method including the steps of:
(a) applying a machine-based transfer learning process to prior result data, the application of the transfer learning process resulting in the generation of predictive data;
(b) selecting one or more parameter values to be used in making the product based on the generated predictive data;
(c) making the whole or a part of the product using the selected one or more parameter values.

2. The method of claim 1, wherein the prior result data includes prior parameter values for making the product and one or more prior product characteristics corresponding to the prior parameter values.

3. The method of claim 2, wherein the prior parameter values and the corresponding prior product characteristics includes respectively parameter values and corresponding product characteristics derived from prior executions of the method for making the product.

4. The method of claim 2 or 3, wherein the transfer learning process includes comparing a first group of the prior parameter values and the corresponding prior product characteristics with a second group of the prior parameter values and the corresponding prior product characteristics.

5. The method of claim 4, wherein the second group of the prior parameter values and the prior product characteristics are derived under different experimental conditions from the first group of the prior parameter values and the prior product characteristics.

6. The method of claim 5, wherein the predictive data includes predictive parameter values for making the product and one or more corresponding predictive product characteristics, and wherein the predictive parameter values and the corresponding predictive product characteristics are generated by the transfer learning process based on the prior parameter values and the corresponding prior product characteristics.

7. The method of claim 6, wherein the predictive parameter values and the corresponding predictive product characteristics are generated based on a difference between the first group of the prior parameter values and the corresponding prior product characteristics and the second group of the prior parameter values and the corresponding prior product characteristics.

8. The method of claim 7, wherein the difference is estimated using: a Gaussian process model, a Bayesian Neural Network, or a Bayesian non-linear regression model.

9. The method of claim 2, wherein the prior parameter values and the corresponding prior product characteristics are simulated data generated based on a reference model.

10. The method of claim 1, wherein
the one or more parameter values is selected using a Bayesian optimisation process.

11. A method used in making a product, wherein a characteristic of the product is at least in part determined by values of parameters used in making the product, the method including the steps of:
(a) applying a machine-based transfer learning process to prior result data, the application of the transfer learning process resulting in the generation of predictive data;
(b) selecting one or more parameter values to be used in making the product based on the generated predictive data;
(c) making the whole or a part of the product using the selected one or more parameter values; and
(d) iterating steps (a) to (c) until the whole or part of the made product exhibits one or more desired product characteristics.

12. The method of claim 11, further including:
(e) outputting the one or more parameter values that were used in making the whole or part of the product which exhibited the one or more desired product characteristics.

13. The method of claim 11, further including:
(f) making the whole product using the selected one or more parameter values.

14. A method used in making a product, wherein a characteristic of the product is at least in part determined by values of parameters used in making the product, the method including the steps of:
(a) applying a machine-based transfer learning process to prior result data, the application of the transfer learning process resulting in the generation of predictive data;
(b) selecting one or more parameter values to be used in making the product based on the generated predictive data;
(c) making or simulating the making of the whole or a part of the product using the selected one or more parameter values.

15. A method used in making a product, wherein a characteristic of the product is at least in part determined by values of parameters used in making the product, the method including the steps of:
(a) applying a machine-based transfer learning process to prior result data, the application of the transfer learning process resulting in the generation of predictive data;
(b) selecting one or more parameter values to be used in making the product based on the generated predictive data;
(c) making or simulating the making of the whole or a part of the product using the selected one or more parameter values; and
(d) iterating steps (a) to (c) until the whole or part of the made or simulated product exhibits one or more desired product characteristics.

16. The method of claim 15, further including:
(e) outputting the one or more parameter values that were used in making or simulating the making of the whole or part of the product which exhibited the desired one or more product characteristics.

17. The method of claim 15, further including:
(f) making or simulating the whole product using the selected one or more parameter values.

18. A method used in making a product, wherein a characteristic of the product is at least in part determined by values of parameters used in making the product, the method including the steps of:
(a) applying a machine-based transfer learning process to prior result data, the application of the transfer learning process resulting in the generation of predictive data;
(b) selecting one or more parameter values to be used in making the product based on the generated predictive data;
(c) simulating the making of the whole or a part of the product using the selected one or more parameter values, and testing the product characteristic of the simulated whole or part of the product;
(d) iterating steps (a)-(c) until the whole or part of the simulated product exhibits one or more desired product characteristics;
(e) outputting the one or more parameter values that were used in simulating the whole or part of the product which exhibited the one or more desired product characteristics.

19. The method of claim 18, further including:
(f) making the whole product using the output one or more parameter values.

20. A system used in making a product, wherein a characteristic of the product is at least in part determined by values of parameters used in making the product, the system including:
at least one computer hardware processor;
at least one computer-readable storage medium storing program instructions executable by the at least one computer hardware processor to:
(a) apply a machine-based transfer learning process to prior result data, the application of the transfer learning process resulting in the generation of predictive data;
(b) select one or more parameter values to be used in making or simulating the making of the whole or a part of the product based on the generated predictive data; and
(c) output the selected one or more parameter values.

21. The system of claim 20, further including:
a product making apparatus;
wherein the product making apparatus receives the output one or more parameter values from the processor, and makes or simulates the making of the whole or a part of the product using the selected one or more parameter values.

22. The system of claim 20, further including:
a data storage component, storing the prior result data.

23. A system used in making a product, wherein a characteristic of the product is at least in part determined by values of parameters used in making the product, the system including:
at least one computer hardware processor;
a product making apparatus;
a product testing apparatus;
at least one computer-readable storage medium storing program instructions executable by the at least one computer hardware processor to:
(a) apply a machine-based transfer learning process to prior result data, the application of the transfer learning process resulting in the generation of predictive data;
(b) select one or more parameter values to be used in making or simulating the making of the whole or a part of the product based on the generated predictive data;
(c) control the product making apparatus to make or simulate the making of the whole or a part of the product;
(d) control the product testing apparatus to test one or more product characteristics of the whole or part of the product made or simulated;
(e) determine whether the whole or part of the made or simulated product exhibits one or more desired product characteristics; and
(f) iterate steps (a)-(e) until the whole or part of the made or simulated product exhibits one or more desired product characteristics.

24. The system of claim 23, wherein the stored program instructions is further executed by the at least one computer hardware processor to:
(g) output the one or more parameter values that, when used in the making or simulating of the whole or a part of the product, result in the making or simulating of the whole or part of the product exhibiting the one or more desired product characteristics.

25. The system of claim 23, further including:
a data storage component, storing the prior result data.
